(19) United States
(12) Patent Application Publication
(10) Pub. No.: US 2008/0136334 A1
(43) Pub. Date: Jun. 12, 2008

(54) SYSTEM AND METHOD FOR CONTROLLING LIGHTING

(76) Inventors: Shane P. Robinson, Gibsons (CA); Bojana Bjeljac, Burnaby (CA); Duncan L. B. Smith, Surrey (CA); Stefan Poli, Langley (CA)

Correspondence Address: PROCOPIO, CORY, HARGREAVES & SAVITCH LLP, 530 B STREET, SUITE 2100, SAN DIEGO, CA, 92101, US

(21) Appl. No.: 11/955,196

(22) Filed: Dec. 12, 2007

Related U.S. Application Data
(60) Provisional application No. 60/968,002, filed on Aug. 24, 2007.

(30) Foreign Application Priority Data
Dec. 12, 2006 (CA) 2,570,952
May 3, 2007 (CA) 2,587,304

(51) Int. Cl. H05B 37/02

(52) U.S. Cl. 315/151; 315/363; 315/149; 315/158; 315/361

(57) ABSTRACT

A system and method for controlling lighting are described. In general, the system and method may be used for controlling generation of light from the one or more lighting devices within a lighting system, in response to an external input. The control system generally comprises a control interface module and a light generation module. The control interface module is configured to receive the external input and convert same in accordance with a predefined internal control protocol. The light generation module is communicatively linked to the control interface module to receive the converted input and is operatively linked to the one or more light-emitting element modules for controlling generation of light thereby in accordance with the converted input. In one example, the light generation module is either interchangeable or interchangeably adaptable to receive the external input in accordance with one of two or more control protocols.

### FIELD OF THE INVENTION

The invention pertains to the field of lighting and in particular to a system and method for controlling lighting.

### BACKGROUND

Advances in the development and improvements of the luminous flux of light-emitting devices such as solid-state semiconductor and organic light-emitting diodes (LEDs) have made these devices suitable for use in general illumination applications, including architectural, entertainment, and roadway lighting. Light-emitting diodes are becoming increasingly competitive with light sources such as incandescent, fluorescent, and high-intensity discharge lamps. For example, various LED-based light sources, which may include different combinations of LEDs and optionally other light-emitting devices and/or luminous devices/materials, can be used and controlled to provide a desired output.

Further LED-based light sources have been disclosed to comprise a feedback system enabling such light sources to adjust an output of the light-source's LEDs as a function of a feedback signal in order to substantially maintain a desired output. For example, feedback signals related to light source output colour, intensity or operating temperature are used to adjust an output of the light source to substantially maintain a pre-set operating condition.

Also, with the increasing selection of LED wavelengths to choose from, white light and colour changing LED light sources are becoming more popular. As such, there is an ever present need for improved control over the light output from such light sources.

Some challenges, however, still need to be resolved to adapt current and upcoming LED technology to general illumination applications. For instance, in order to make general purpose LED-based light sources competitive with, and ultimately surpass, currently available general purpose light sources, techniques must be developed to improve and possibly optimise the general illumination characteristics of such LED-based devices via optimised operational parameters.

Other challenges arise from the diversity of control systems and processes implemented in the art, such that incompatibilities between systems and/or products provided by different parties who may favour a different control standard or protocol, can complicate installation and/or operation of such systems when combining different products, and hinder progress or improvements when upgrades or revised versions of existing products are made available.

Furthermore, the lack of compatibility between different hardware and/or firmware components associated with different lighting devices or systems can be problematic. For example, operative characteristics of light-emitting diodes can vary dramatically even for those having similar physical characteristics.

Therefore, there is a need for a system and method for controlling lighting that overcomes some of the drawbacks of known systems.

This background information is provided to reveal information believed by the applicant to be of possible relevance to the invention. No admission is necessarily intended, nor should be construed, that any of the preceding information constitutes prior art against the invention.

### SUMMARY OF THE INVENTION

An object of the invention is to provide a system and method for controlling lighting. In accordance with an aspect of the invention, there is provided a system for controlling generation of light from one or more light-emitting elements in response to an external input, the system comprising: a control interface module configured to receive the external input and convert same in accordance with a predefined internal control protocol, and a light generation module communicatively linked to said control interface module and operatively linked to the one or more light-emitting elements for controlling same in accordance with said converted input.

In accordance with another aspect of the invention, there is provided a method for controlling generation of light from one or more light-emitting elements of a lighting device in response to an external input, the method comprising the steps of: receiving the external input; converting the external input in accordance with a predefined internal control protocol; and controlling generation of light from the one or more light-emitting elements in accordance with said converted input.

In accordance with another aspect of the invention, there is provided a lighting system comprising: an external input module; and one or more lighting modules each comprising one or more light-emitting element modules and a slave control unit operatively coupled thereto for driving said one or more light-emitting element modules; each said slave control unit being communicatively linked to said external input module to receive an external input therefrom via a control interface; said control interface configured to convert said external input in accordance with a predefined internal control protocol operable by said slave control unit to drive said one or more light-emitting element modules in accordance therewith.

### BRIEF DESCRIPTION OF THE FIGURES

FIG. 1 is a high level diagrammatical representation of a drive and control system for a lighting device in a lighting system, in accordance with one embodiment of the invention.

FIG. 2 is a high level diagrammatical representation of a drive and control system for a lighting device in a lighting system, in accordance with another embodiment of the invention.

FIG. 3 is a high level diagrammatical representation of a drive and control system for a lighting device in a lighting system, in accordance with another embodiment of the invention.

FIG. 4 is a box diagram of a firmware module architecture of a drive and control system for a lighting device in a lighting system, in accordance with one embodiment of the invention.

FIG. 5 is a box diagram of a firmware module and module interface architecture of a drive and control system for a lighting device in a lighting system, in accordance with one embodiment of the invention.

FIG. 6 is a box diagram of a firmware module and module interface architecture of a drive and control system for a lighting device in a lighting system, in accordance with another embodiment of the invention.

FIG. 7 is a box diagram of a firmware module and module interface architecture of a drive and control system of a lighting device in a lighting system, depicting in greater detail a module support thereof, in accordance with one embodiment of the invention.

FIG. 8 is a box diagram of a firmware module and module interface architecture of a drive and control system for a lighting device in a lighting system, depicting in greater detail a module support thereof, in accordance with another embodiment of the invention.

FIG. 9 is a box diagram of a firmware module and module interface architecture of a control interface module usable in a drive and control system for a lighting device in a lighting system, in accordance with one embodiment of the invention.

FIG. 10 is a box diagram of a firmware module and module interface architecture of a light generation module usable in a drive and control system for a lighting device in a lighting system, in accordance with one embodiment of the invention.

FIG. 11 is a box diagram of a firmware module and module interface architecture of a combined control interface and light generation module usable in a drive and control system for a lighting device in a lighting system, in accordance with one embodiment of the invention.

FIG. 12 is a diagrammatical representation of a lighting system in accordance with one embodiment of the invention;

FIG. 13 is a diagrammatical representation of a system architecture for use with a manual control interface in accordance with one embodiment of the invention.

FIG. 14 is a diagrammatical representation of a system architecture for use with a manual control interface and a proprietary protocol control interface in accordance with one embodiment of the invention.

FIG. 15 is a diagrammatical representation of a logic architecture of the slave control unit in accordance with one embodiment of the invention.

FIG. 16 is a block diagram of a control interface in accordance with one embodiment of the invention.

FIG. 17 is a block diagram of a firmware architecture, for example of the embodiment illustrated in FIG. 16.

FIG. 18 is a block diagram of a manual control interface in accordance with one embodiment of the invention.

FIG. 19 is a block diagram of a firmware architecture, for example of the embodiment illustrated in FIG. 18.

FIG. 20 is a block diagram of a manual control interface in accordance with another embodiment of the invention.

FIG. 21 is a block diagram of a firmware architecture, for example of the embodiment illustrated in FIG. 20.

FIG. 22 is a diagrammatical representation of a lighting device in accordance with one embodiment of the invention.

FIG. 23 is a high level diagram of a hardware/firmware architecture of a lighting device, in accordance with one embodiment of the invention.

FIG. 24 is a further detailed diagram of the firmware architecture of FIG. 23.

### DETAILED DESCRIPTION OF THE INVENTION

### Definitions

The term “light-emitting element” is used to define a device that emits radiation in a region or combination of regions of the electromagnetic spectrum for example, the visible region, infrared and/or ultraviolet region, when activated by applying a potential difference across it or passing a current through it, for example. Therefore a light-emitting element can have monochromatic, quasi-monochromatic, polychromatic or broadband spectral emission characteristics. Examples of light-emitting elements include semiconductor, organic, or polymer/polymeric light-emitting diodes, optically pumped phosphor coated light-emitting diodes, optically pumped nano-crystal light-emitting diodes or other similar devices as would be readily understood by a worker skilled in the art. Furthermore, the term light-emitting element is used to define the specific device that emits the radiation, for example a LED die, and can equally be used to define a combination of the specific device that emits the radiation together with a housing or package within which the specific device or devices are placed.

The term “light” in the context of “light generation” is used to define radiation in a region or combination of regions of the electromagnetic spectrum for example, the visible region, infrared and/or ultraviolet region. Therefore generated light can comprise monochromatic, quasi-monochromatic, polychromatic or broadband spectral emission characteristics, and be emitted from one or more lighting devices, e.g. from the one or more light-emitting elements and/or other such light source thereof, appropriately configured to provide such characteristics.

The term “control protocol” is used to define a protocol by which control parameters, instructions, processes, commands, etc. may be communicated to and/or implemented by one or more lighting modules and/or devices of a lighting system (e.g. as described herein), or control interface and/or light generation module(s) thereof, either directly or indirectly, to ultimately control a luminous output of the lighting device/module(s) of the system. A control protocol as used herein may include, but is not limited to, a lighting device control process (e.g. method, process, algorithm, etc.); a data format of an input for, or an output of such a process; a set of units and/or parameters by which the controlled output of the one or more lighting devices, or of its one or more constituents, may be defined; a communication protocol by which such parameters, inputs and/or outputs may be communicated between various components and/or modules of a given lighting system; a proprietary or industry standard for defining various control parameters, communicating such parameters between various components/modules of a control system and/or operating and interfacing with such components for the implementation of a control sequence or process, for example. It will be appreciated that such control protocols may be implemented to control various elements and/or functions of the one or more lighting devices (e.g. lighting device intensity, chromaticity, spectral power distribution, colour quality or rendering ability, luminous efficacy, wall-plug efficiency, etc.), such as via one or more control interface and/or light generation modules integrated therein or operatively coupled thereto, as well as provide administrative control of the control interface module(s), light generation module(s), and/or other such firmware/software modules (e.g. system update and/or upgrade, etc.).

The term “preset” is used to define a sequence of one or more steps wherein a step is a unique set of values that defines a luminous output. For example, a given set of values may include, but is not limited to, a chromaticity, a luminous flux output and duration, and/or other such values used to define a given luminous output of a particular lighting device, or system thereof. It will be appreciated by the person skilled in the art that different sets of different values, which may differ in number, format and/or be defined in accordance with different illumination standards, may be considered herein without departing from the general scope of this definition. The sequence of one or more steps is generally used to define a desired operation of an array of one or more light-emitting elements, for example.

As used herein, the term “about” refers to a +/−10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The invention provides a system and method for controlling lighting, for example from the one or more lighting devices and/or modules of a lighting system. In particular, and in accordance with one embodiment of the invention, there is provided a system and method for controlling generation of light from one or more light-emitting elements of a lighting device in response to an external input. The system generally comprises a control interface module and a light generation module. The control interface module is generally configured to receive the external input and convert same in accordance with a predefined internal control standard. The light generation module is communicatively linked to the control interface module to receive the converted input, and is operatively linked to the one or more light-emitting elements for controlling generation of light thereby in accordance with the converted input. Accordingly, the system provides for the compatibility of a light generation module, configured to activate one or more light-emitting elements to emit a controlled light output in accordance with an internal control standard, with an external input which may not be provided in accordance with a same standard, and as such, would otherwise be unusable to operate the light-emitting element(s) via the light generation module. Such interconnectivity and/or interoperability provides greater flexibility in total system design, upgrade and implementation allowing for a variety of prior and newly developed components to be used interchangeably while reducing costs related to potentially labour intensive re-installations and/or costly retrofitting solutions.

According to some embodiments, the architecture of these systems can therefore facilitate the design of different light generation modules, control interface modules and/or integrated control interface/light generation modules that can, for example, be interconnected in a flexible manner; share common hardware and/or firmware platforms to allow improved reuse of previously developed modules; allow new control interface modules to be easily incorporated and to interoperate with previously developed light generation modules; allow new light control algorithms, techniques and methods to be easily incorporated and to interoperate with previously developed control interface modules; and/or include interfaces for control, configuration and maintenance of the control interface module, light generation module, integrated control interface/light generation module and/or other such modules using applications running on a personal computer, for example, to name few.

For example, in one embodiment, the control interface module is either interchangeable or interchangeably adaptable to receive the external input in accordance with one of two or more control protocols, and convert same in accordance with a same predetermined internal control protocol, thereby allowing the system to operate in response to an external output provided in accordance with any one of these protocols. Such a system could thus be designed to implement control of an existing lighting device and light generation module installation by adapting a control interface module communicatively linked thereto to provide adequate conversion of an external input to communicate a control signal to the light generation module in accordance with a predetermined internal control protocol. This and other advantages of such embodiments will become more apparent to the person of skill in the art upon further reading the present description.

Furthermore, in some embodiments, greater system flexibility and reusability is achieved by providing adaptable and/or standardised firmware within each module to facilitate adaptation to new or different operating and/or control conditions.

As will be described in greater detail below, the firmware used in each module may, for example, provide a compact real time framework that provides access to standard devices as well as real time control of a system processor; define a standard set of high level operations that can be performed on light and implement these in a manner that is independent of the actual light generation hardware and/or firmware; support a Light Control Language (LCL) as the standard for communication of lighting commands among modules; define an isolated environment with standard interfaces in which the physical control of the light output may be implemented; define a standard set of high level operations and features for configuration, monitoring and maintenance functions; and/or support a Module Control Language (MCL) to implement a command interface for these features, to name a few. In addition, in order to simplify implementation of the embedded firmware, in accordance with some embodiments, all languages may be defined to share the same structure and semantics, for example.

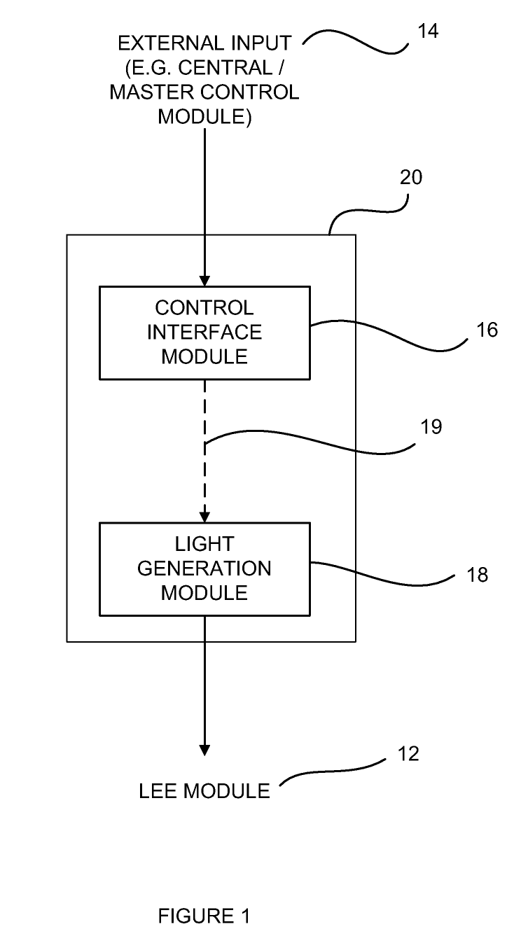

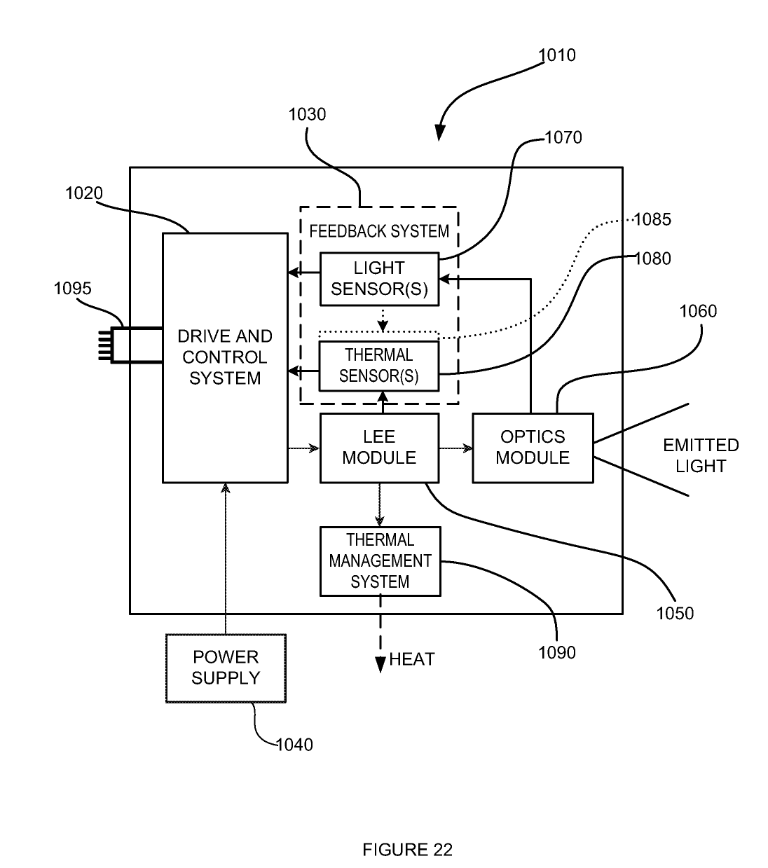

With reference to FIG. 1, and in accordance with one embodiment of the invention, the drive and control system of a lighting device (e.g. such as system 1020 of FIG. 22), illustratively referred to herein using the numeral 20, is depicted to comprise a control interface module 16 configured to receive an external input 14 (e.g. from a distinct/remote or integrated I/O module, a central/master control module, and/or other such external input modules), and a light generation module 18 operatively linked thereto, for example via link 19, which is operatively linked to one or more light-emitting element modules 12 to control same, and the light-emitting element(s) thereof, in accordance with the received external input. In order to implement control of the one or more light-emitting element modules 12 in response to the external input 14, the external input is first converted by the control interface module 16 in accordance with a predetermined internal control protocol, to be interpreted by the light generation module 18 for operating the one or more light-emitting element modules 12 in accordance therewith.

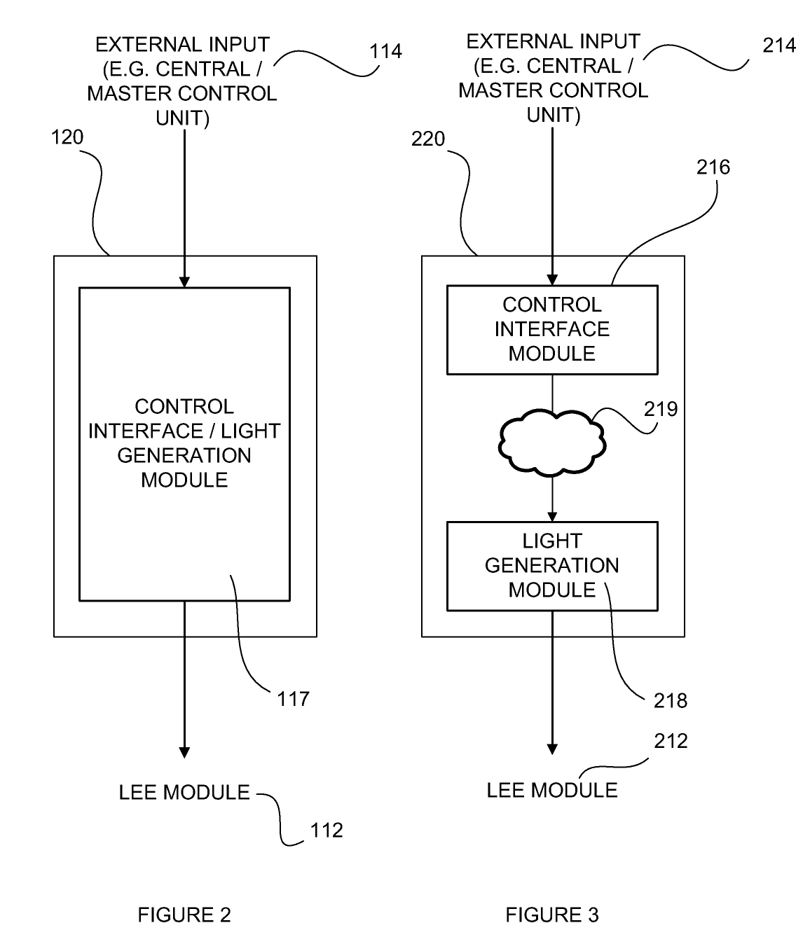

In one embodiment, the control interface and light generation modules are operatively linked as part of a common module or device, such as an integrated control interface/light generation module. Such a configuration may be provided, for example, in a common hardware system wherein the functional elements of each module are provided over a same hardware platform, for example, operating as a single unit, such as an integrated control unit (e.g. self-contained lighting device) or a slave control unit to a master or central control unit (e.g. distributed lighting system), for example. For example, and with reference to the embodiment of FIG. 2, the drive and control system, illustratively depicted as system 120, comprises an integrated system architecture comprising a combined control interface and light generation module 117 configured to implement the functions of each module in an integrated manner. Namely, the control interface module component of the integrated architecture receives an external input 114, converts this input in accordance with a predetermined internal control protocol, which is interpreted by an integrated light generation module communicatively linked thereto, to control the one or more light-emitting element modules 112 operatively coupled thereto.

In another embodiment, the control interface and light generation modules may be communicatively linked as part of distinct modules or devices, namely consisting of a distinct control interface module and light generation module respectively. Such a configuration may be provided for example, in a common or distributed hardware system wherein the functional elements of each module are provided over a same or different hardware platforms, for example, communicatively linked to operate as a cooperative unit, such as an integrated control unit (e.g. self-contained lighting device) or a slave control unit to a master or central control unit (e.g. distributed lighting system), for example. For example, in the embodiment of FIG. 3, the drive and control system, illustratively depicted as system 220, comprises a distinct control interface module 216 configured to receive an external input 214, and a distinct light generation module 218 operatively linked thereto via network 219, which is operatively linked to the one or more light-emitting element modules 212 to control same in accordance with the received external input, as described above.

The person of skill in the art will appreciate that any combination of integrated and/or distributed modules may be considered herein without departing from the general scope and nature of the present disclosure, thereby allowing for flexibility in system design and implementation for a given context or application.

As introduced above, and in accordance with different embodiments of the invention, the following further describes a control system and method for controlling illumination provided by a lighting system. In general, the lighting system comprises a master control unit and one or more lighting modules or devices communicatively linked thereto, each one of which comprising a light-emitting element module and a slave control unit operatively coupled thereto for driving the light-emitting element(s) thereof in accordance with external inputs (e.g. control signals and/or commands) communicated thereto by the master control module, remote/distinct or integrated input/output (I/O) module, or other such external input modules, for example.

For instance, each slave control unit may be communicatively linked to a master control unit to receive external input therefrom. In one embodiment, the master and slave control units are linked via a control interface module configured to convert the external input in accordance with a predefined internal control protocol operable by the slave control unit (e.g. by a light generation module implemented thereon) to drive the one or more light-emitting elements coupled thereto. Accordingly, commands and/or control sequences communicated by the master control unit, which may possibly be configured in accordance with a particular external control protocol, may be implemented by each lighting module via its respective slave control unit, in accordance with a common or respective internal protocol that may different than the particular external control protocol used by the master control unit.

The lighting systems and devices, as will be described below in accordance with various embodiments of the invention, may provide different solid-state lighting solutions, for example, adapted to provide illumination via the controlled operation of the one or more light-emitting element modules provided by the one or more lighting devices or modules of the system. For example, in some embodiments, a modular solid-state lighting system is provided comprising one or more lighting devices, each comprising a light-emitting element module (e.g. comprising one or more arrays of one or more light-emitting elements) and a slave control unit configured to provide the control signals to the light-emitting element module thereby controlling activation of the one or more light-emitting elements thereof. A power supply module operatively coupled to the lighting device or module provides the required power format to the slave control unit. A master control module can be operatively coupled to a given lighting device or module (e.g. directly or indirectly via one or more intermediary devices and/or modules) and be configured to provide operational control signals to the slave control unit thereof.

The modular solid-state lighting system may further comprise an I/O module operatively coupled to the lighting device, wherein the I/O module can provide a means for input/output to and from the lighting device, and in particular to and from the slave control unit thereof. An optics module may be further optically coupled to the light-emitting element module, thereby enabling the manipulation of the light generated by the one or more light-emitting elements of this module to provide a desired luminous effect.

The slave control unit can be configured to interface with a variety of external module configurations. For example the slave control unit can be configured, for example using different firmware architectures (e.g. via different control interface modules), to enable the interfacing with different I/O modules. For example, an I/O module can be configured to enable one or more of the following types of control: manual control, DMX control, DALI control, proprietary control or other control formats applicable to a solid-state lighting device as would be readily understood by a person of ordinary skill in the art. Furthermore, and in accordance with one embodiment, an I/O module is configured to provide instructions to a slave control unit, wherein the I/O module is configured as a user interface or a communication port, for example. A communication port can be configured to receive and send information in one or more of a plurality of communication protocols for example, DMX, DALI, RS-485, I2C, RS-232, Ethernet, a proprietary protocol or other communication protocol as would be readily understood by a worker skilled in the art.

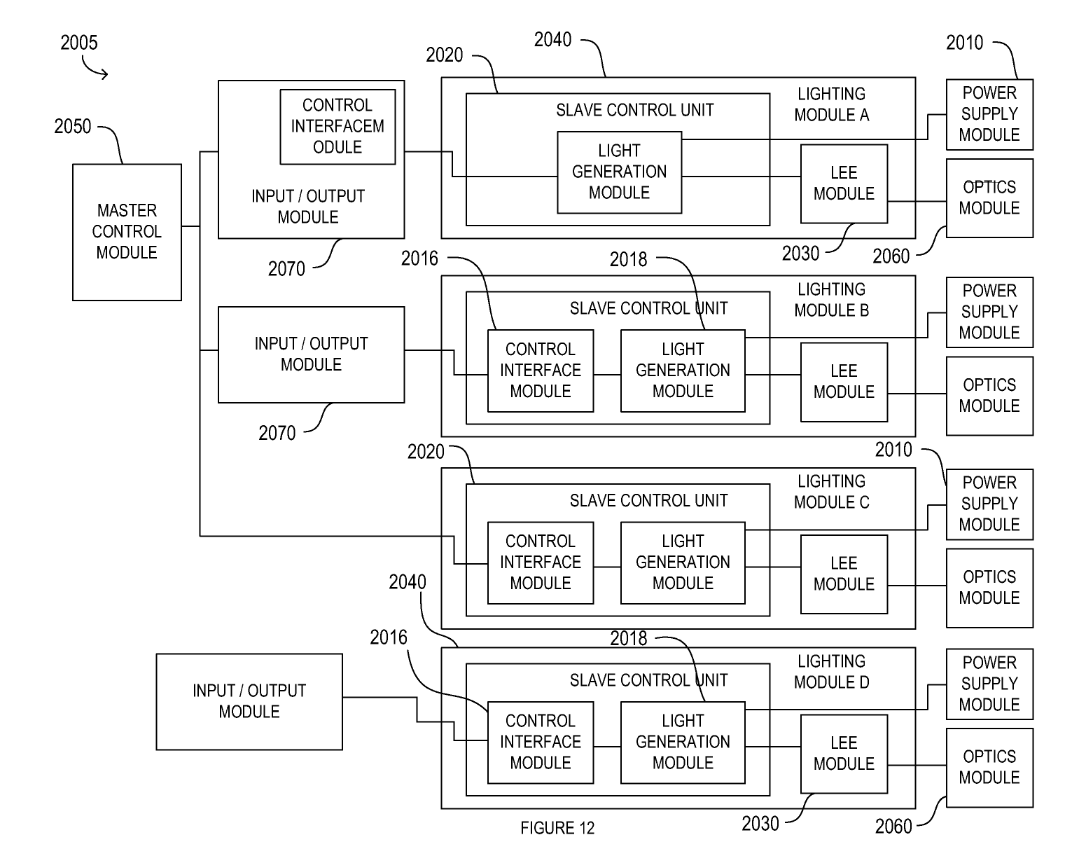

With reference to FIG. 12, and in accordance with an embodiment of the invention, a lighting system, generally referred to using the numeral 2005, will now be described. The lighting system 2005 generally comprises one or more lighting devices or modules 2040 (e.g. as in modules A to D) configured to received an external control input from any one or more of a master control module 2050 (e.g. lighting modules A, B and C), an integral and/or remote input/output (I/O) module 2070 (e.g. lighting modules A, B and D), and/or other such external input modules. A given lighting module may also, or alternatively, be configured to receive an external input during manufacturing, assembly and/or installation for self-contained operation, for example, possibly for operation without or with infrequent interaction with a master control or I/O module.

In general, each lighting module 2040 comprises a light-emitting element (LEE) module 2030, which generally comprises one or more arrays each of one or more light-emitting elements, and a slave control unit 2020 operatively configured to implement instructions received form the master control module 2050 and/or I/O module 2070 to operate the LEE module 2030 associated therewith, thereby controlling activation of the one or more light-emitting elements thereof.

A same or distinct power supply module 2010 is further operatively coupled to each lighting module 2040 to provide the required power format to the slave control unit 2020 thereof for operating the respective LEE modules.

A respective or combined optics module 2060 may further be coupled to the lighting module(s) 2040, for example optically coupled to respective or a combination of light-emitting element modules 2030, thereby enabling the manipulation of the light generated by the one or more light-emitting elements thereof.

As depicted in the various examples of FIG. 12, each slave control unit 2020 may provide a hardware platform for implementing one or more firmware and/or software modules configured to receive the external input form the master control module 2050 and/or associated I/O module 2070, and interpret same to control the respective LEE modules 2030 to generate light in accordance with the instructions contained within the external input. For example, as introduced above and as will be described in greater detail below, each slave control unit 2020 may be configured to implement a control interface module adapted to receive the external input and convert same in accordance with a predefined internal control protocol, and a light generation module adapted to interpret this converted input to drive the light-emitting elements of an associated LEE module 2030. In another example, the firmware modules of a given lighting device are distributed over two or more platforms, thereby distributing the functionality of each module over two or more operatively coupled devices. For instance, as depicted for lighting module A of FIG. 12, a control interface module is provided by the I/O module 2070, which is itself configured to first receive the external input from the master control module 2050 and convert same for implementation of the instructions and commands contained therein by the light generation module of the lighting module's slave control unit 2020. It will be appreciated by the person of ordinary skill in the art that various combinations and distributions of hardware, firmware and/or software modules may be considered herein, as will be exemplified by the various embodiments of the invention described below, without departing from the general scope and nature of the present disclosure.

In one embodiment, a master control module 2050 is not included. In this case the lighting module(s) may be used as a stand alone apparatus, operating under manual control via an interface module 2070 (e.g. see lighting module D), or under preset or preconfigured conditions, for example.

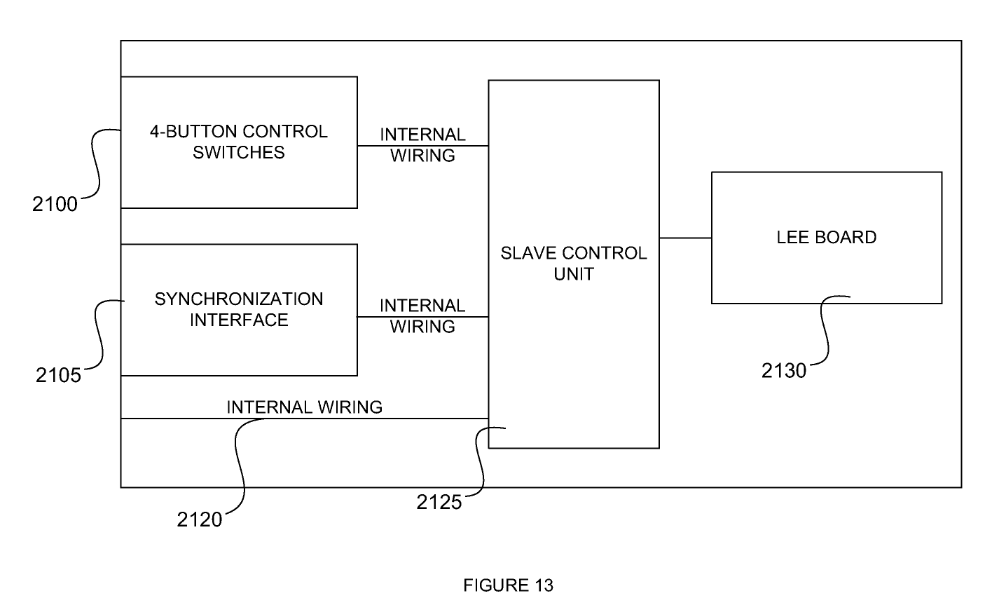

In another embodiment, a networked group of lighting modules may be operated in synchronisation with each other via communicative connection from a master control module to each slave control module, either directly or via one more intermediary devices such as a common or respective I/O module. The master controller used in this instance could be, for example, a DMX controller. The plurality of lighting devices in the lighting system can be synchronised with each other, for example, via a synchronisation interface, as shown in the embodiments of FIGS. 13, 14, 18 and 19.

In some embodiments, the lighting system comprises a plurality of lighting modules, and the master control module can enable a desired functionality of the plurality of lighting modules.

In one embodiment, the modular configuration of the lighting system can provide a means for different manufacturers to specify, design and manufacture the different modules. This configuration may provide ease of removal and replacement of particular modules and may enable one to alter and/or maintain the lighting system without having to change the entire system. For example, hardware and/or firmware modules which form the lighting system can be interconnected creating different types of lighting devices, modules and systems. For example, multiple modules possibly manufactured and configured by different parties, can be interconnected to each other to create a network of lighting devices or modules, operatively controlled by a master controller, or other such external control modules.

### Lighting Device

The lighting device described herein, in accordance with different embodiments of the invention, may be used on its own or in conjunction with other devices and/or modules to produce white light with specific colour temperatures, or light of an other chromaticity within the available colour gamut of the light-emitting elements associated therewith, for example. Each lighting device may comprise one or more light-emitting elements and a drive and control system therefore (e.g. see lighting modules 2040 of FIGS. 12, 16 and 18). The device may further comprise various combinations of other components that may include, but are not limited to, a feedback system, a thermal management system, an optics module, and a communication system enabling communication between different lighting devices, light generation modules and/or other control systems/modules, for example. Depending on its configuration, the lighting device can operate autonomously or its functionality can be determined based on both internal signals and externally received signals, solely externally received signals or solely internal signals, for example.

With reference to FIG. 22, the various components of a lighting device 1010, in accordance with one embodiment of the invention, are diagrammatically illustrated. The lighting device 1010 generally comprises a light-emitting element module 1050 comprising one or more arrays of one or more light-emitting elements. A power supply, depicted herein as an external power source, supply and/or module 1040 provides power to the lighting device 1010 wherein this provided power is regulated by a drive and control system 1020 (e.g. in some embodiments comprising an integrated and/or distributed slave control unit optionally comprising control interface and/or light generation modules, as described below). This power regulation can include the conversion of the supplied power to a desired input power level that can be determined based on characteristics of the light-emitting elements within the device, for example. In addition to power conversion, the drive and control system 1020 provides a means for controlling the transmission of control signals to the light-emitting elements thereby controlling their activation. The drive and control system 1020 can receive input data from within the lighting device 1010, for example from the feedback system 1030, and/or may receive external input data from other lighting devices and/or other controlling devices (e.g. from a central controller or master control unit, as described below). An optional communication port 1095 can provide the drive and control system 1020 with the capability for both input and output of signals to and from the device 1010, respectively, for example, within the context of a lighting device at least in part controlled by a distinct controller or control interface, or again when the lighting device 1010 is adapted to act, at least in part, as a controller or control interface to a networked or associated lighting device.

The feedback system 1030 of device 1010 can comprise one or more forms of detectors, sensors and/or other similar devices, commonly and interchangeably referred to herein as sensing elements. For example, one or more optical sensors, such as optical sensor 1070, and one or more thermal sensors, such as thermal sensor 1080 and/or thermal sensor 1085, can be integrated within, or operatively coupled to, the feedback system 1030.

In one embodiment, the optical sensor 1070 can detect and provide information to the drive and control system 1020 that can relate to the luminous flux and chromaticity of the illumination generated by the light-emitting element(s), to ambient daylight readings, and/or to other such optical readings possibly relevant to the proper and/or optimal operation of the lighting device 1010, for example. This form of information can enable the drive and control system 1020 to modify the activation of the light-emitting element(s) within the device 1010 in order to achieve and/or maintain one or more target illumination characteristics or presets, for example. Using feedback data acquired via the optical sensor 1070, the target illumination characteristic(s) or presets may be achieved, for example, despite possible fluctuations in light-emitting element intensities, peak wavelength shifts and/or spectral broadening due to, for example, one or more of light-emitting element junction temperature variations, light-emitting element ageing and/or long-term optics degradation, and other such possible fluctuations and/or variations in the operational characteristics of the lighting device 1010. Other such characteristics should be apparent to the person of skill in the art and are therefore not meant to depart from the general scope and nature of the present disclosure.

As introduced above, in one embodiment, the feedback system 1030 comprises a thermal sensor 1080 configured to detect, for example, the temperature of the substrate on which the light-emitting elements are mounted, the temperature of one of, or of each of the light-emitting elements, the temperature within the lighting device itself, and/or the temperature of other such components of the lighting device which may vary or fluctuate during operation. This temperature information can be transferred to the drive and control system 1020 thereby enabling the modification of the activation of the light-emitting elements in order to reduce thermal damage of the light-emitting elements due to overheating, for example, thereby improving the longevity of these components. In addition, the thermal sensor 1080 can be used in a feedforward system (not shown) to achieve one or more target illumination characteristics or presets regardless of variations in operating temperatures and/or light-emitting element junction temperatures, for example.

In another embodiment, an additional thermal sensor 1085, depicted herein in dotted lines as a distinct or common thermal sensor, is provided and configured to detect the temperature of the light sensor(s) 1070. This temperature information can be used to adjust the sensor readings to account for the temperature dependencies of the light sensor(s) 1070, for example. In addition, the thermal sensor 1085 can provide a measure of the printed circuit board (PCB) temperature, which can be thermally decoupled from the heat generated by the light-emitting element module 1050, and light-emitting elements thereof, to provide greater determination of heat sources and thermal effects during operation.

As depicted in FIG. 22, the thermal management system 1090 provides a system for transferring heat generated by the light-emitting element module 1050 to a heat sink or other heat dissipation device. The thermal management system may comprise intimate thermal contact with the light-emitting elements, for example, and provide a predefined thermal path for the heat to be transferred away from the light-emitting elements. Optionally, the thermal management system may further provide a means for transferring heat away from the drive and control system 1020. Other such heat management systems and configurations should be apparent to the person of skill in the art and are therefore not meant to depart from the general scope and nature of the present disclosure.

The optics module 1060, as depicted in FIG. 22, receives the illumination created by the light-emitting element module 1050 and provides a means for efficient optical manipulation of this illumination. The optics module 1060 can for example provide a means for the collection and/or collimation of luminous flux emitted by the light-emitting element module 1050 and can provide colour mixing of the emission of multiple light-emitting elements, for example. The optics module 1060 can also provide control over the spatial distribution of light emanating from the lighting device 1010. In addition, the optics module 1060 can provide a means for directing a fraction of the illumination to the light sensor(s) 1070 in order to enable feedback signals to be generated which are representative of the illumination characteristics of the illumination generated by the lighting device 1010.

In one embodiment, the drive and control system 1020 of a lighting device 1010 can operate independently of other external lighting devices and external control systems or controllers.

In another embodiment, the drive and control system 1020 can receive input data from other lighting modules or an external control system or controller via an optional communications port 1095, wherein this data can include status signals, lighting signals, feedback information and operational commands, for example. The drive and control system 1020 can equally transmit this externally received data or internally collected or generated data to other lighting devices or an external control system. This transmission of information can be enabled by the optional communication port 1095 coupled to the drive and control system 1020, for example.

In one embodiment, the lighting device 1010 of FIG. 22 further comprises an Input/Output (I/O) interface (not shown) for enabling a user (e.g. user interface) to input control preferences and/or requirements, possibly dictated by the application for which the lighting device is to be used, and computing means for interpreting these control inputs (e.g. via drive and control system 1020) to control the output of the lighting device 1010. As will be apparent to the person skilled in the art, inputs may be provided via a number of hardware, firmware and/or software means configured to provide a user interface for accepting such inputs from a user of the lighting device 1010. Alternatively, control inputs may be provided to the computing means internally from various pre-programmed control functions. Furthermore, interpretation and processing of the required data and commands for operating the lighting device in accordance with the input controls may be implemented via a combination of hardware, firmware and/or software modules operating independently or in co-operation with one or more integrated and/or communicatively linked computing means.

In an illustrative embodiment described in greater detail below, the I/O interface and computing means are provided by a firmware operating on the hardware architecture of the lighting device 1010. It will be apparent to the person of skill in the art upon reading the following disclosure that other firmware/hardware architectures may be considered to provide similar results, as can other combinations of integrated and/or communicatively linked software/firmware/hardware modules operatively interacting with the drive and control system 1020 of the lighting device 1010 to accept, interpret and process input controls to operate the lighting device in accordance with such input controls.

Furthermore, it will be appreciated that communication between the drive and control system 1020, the light-emitting element module 1050 and the feedback system 1030 can be implemented through various media, whether each element is integrated and hardwired within a same apparatus, such as a self-supported lighting device, or communicatively linked between grouped or networked modules. An optional external control console or the like may also be included to link a number of lighting devices and adapted to provide adaptable control signals thereto.

### Slave Control Unit

The slave control unit is configured to provide control signals to the one or more light-emitting elements within the light-emitting element module. The slave control unit can manipulate the power received from the power supply module prior to provision to the light-emitting element module, thereby enabling the provision of power in a desired format.

The slave control unit can comprise one or more of a variety of types of microprocessors or microcontrollers including central processing units (CPUs). The slave control unit can have one or more A/D converters for monitoring certain lighting parameters. The slave control unit can be operatively coupled to a memory device. For example, the memory device can be integrated into the slave control unit or it can be a memory device connected to the computing device via a suitable communication link. In one embodiment, the slave control unit can store the required voltage and/or current magnitudes of previously determined drive voltages and/or currents in the memory device for subsequent use during operation of the lighting system. The memory device can be configured as an electrically erasable programmable read only memory (EEPROM), electrically programmable read only memory (EPROM), non-volatile random access memory (NVRAM), read-only memory (ROM), programmable read-only memory (PROM), flash memory or other non-volatile memory for storing data. The memory can be used to store data and control instructions, for example, program code, software, microcode or firmware, for monitoring or controlling devices which are coupled to the computing device and which can be provided for execution or processing by the CPU.

In one embodiment, the control system and method can be implemented in an embedded system, hardware and firmware, for example.

In one embodiment, algorithms which can be implemented in firmware on the slave control unit, can be configured to control in real time the correlation between input power supplied by the power supply module and the light output level of the light-emitting element module, thereby allowing a substantially high level of control over the light output while substantially decreasing the power losses and the resultant heat dissipation. Such algorithms may include the analytic modelling of the output spectrum of each light-emitting element colour as the sum of two Gaussians or other bell-shaped curves. Furthermore auto adaptive functions implemented in firmware can provide a means for the hardware of the slave control unit to be adapted to various modules, for example light-emitting element modules or I/O modules, which are configured with different input and output voltage levels. For example, in one embodiment, the firmware includes an algorithm that lowers the power supplied to the one or more light-emitting elements according to the temperature/forward voltage correlation law which can govern the operation of the one or more light-emitting elements.

For example, small improvements in efficiency optimization resulting from an auto-adaptive control may save several watts in a single lighting device, which can count for up to 10% or more of the total power needed for driving an array of light-emitting elements.

In one embodiment, an adaptive control system and method can be used to directly control the forward voltage of one or more light-emitting elements in a serial and/or parallel configuration, or can be used to control the voltage provided to a group of one or more light-emitting elements in a serial and/or parallel configuration.

In one embodiment, the slave control unit is capable of operating with 8-bit resolution control of the light-emitting element module.

In another embodiment, the slave control unit can be configured to operate using 10-bit or greater resolution control of the light-emitting element module. The adjustment in the resolution of the control can be enabled by using a controller having the desired resolution, or alternately by reconfiguring the control signals generated by the slave control unit.

In addition, as introduced above and in accordance with some embodiments of the invention, a lighting device may optionally comprise one or more sensing elements, such as optical, thermal and/or electrical sensors for sensing an operating condition and/or characteristics of the lighting device, and use such sensed characteristics as part of a feedback and/or feedforward system for enhancing or even optimizing the performance of the lighting device with respect to required and/or selected operating conditions (e.g. light-emitting element module operating temperature, power consumption efficiency, etc.) and/or output characteristics (e.g. peak wavelength, spectral power distribution, colour quality, chromaticity, colour temperature, colour rendering index, etc.). Such feedback and/or feedforward systems, may, in some embodiments, be implemented via the slave control unit. For example, sensed operating characteristics of the lighting device may be looped back to the slave control unit and used thereby to adjust one or more operating conditions of the lighting device.

In one embodiment, for example, a sample of the light output by the light-emitting element module is detected by an optical sensor, which forms electrical signals representative of the light falling on it. These signals are passed back to the slave control unit, which takes them into account when providing the required power to the light-emitting element module. Sampling of the output light may be regular or may occur at different rates. For example, the output could be sampled more frequently during changes in the set point and for a period of time following such changes. Furthermore, in accordance with another embodiment, a thermal sensor may be thermally coupled to the optical sensor for monitoring an operating temperature thereof (e.g. the operating characteristics and/or sensitivity of some optical sensors may vary with temperature) and thereby adjust a signal communicated by the optical sensor to the slave control unit, or again adjust an interpretation thereof by the slave control unit, according to this operating temperature.

In another embodiment, the required voltage(s) and/or current(s) to be provided to the light-emitting element module is determined by monitoring the operating temperature of the module, and/or of the light-emitting element(s) thereof, and setting the voltage(s) and/or current(s) according to the desired light output and the output performance of the light-emitting elements at such temperature. The temperature monitored may be the temperature or temperatures of one or more of the individual light-emitting elements within the module, or the temperatures of the junctions of the light-emitting elements may be measured, for example via a forward voltage measurement.

In some embodiments, calibration data used to perform such calculation is stored in the memory of the slave control unit or in memory within the light-emitting element module, and may be stored as a lookup table or as coefficients of an analytic equation, for example.

It will be appreciated by the person of ordinary skill in the art that other types of feedback and/or feedforward systems may be implemented in the present context without departing from the general scope and nature of the present disclosure. It will further be appreciated that operations described herein as implemented by the slave control unit may also be implemented by cooperative hardware/firmware modules operatively coupled to the slave control unit for implementing the above and other such feedback and/or feedforward systems.

### External Input

In general, the various lighting devices/modules of a lighting system, in accordance with some embodiments of the invention, are responsive to an external input (e.g. see external input 14, 114, . . . 914 of FIGS. 1 to 11), generally of the form of an external control signal or command, to be interpreted by the system for operating one or more light-emitting element modules (e.g. see light-emitting element module(s) 12, 112, . . . 912 of FIGS. 1 to 11), operatively coupled thereto, in a controlled manner. For example, the external input is generally provided by one or more systems and/or devices available to the user of the system configured to control the light output of the system.

In general, external control may be provided uniquely for a given lighting device, or combination thereof, or provided through a networked lighting system, for example, operatively disposed to provide lighting instructions and/or commands to a plurality of lighting devices, either via a common control network, or via a distributed network of components configured to implement a same or different lighting conditions for different lighting devices, or combinations thereof.

For example, in one embodiment, the external input is provided by a master controller (e.g. such as master control module 2050 of FIG. 12) configured to provide control signals to the respective slave control units of each lighting device within a lighting system. Such control signals may be communicated by the master controller over, for example, a private, shared, and/or proprietary communications network, such as DALI or DMX, to control the lighting devices of the system.

In general, the master controller may comprise one or more of a variety of types of microprocessors or microcontrollers including central processing units (CPUs). The master controller can further be operatively coupled to a memory device. For example, the memory device can be integrated into the master controller or it can be a memory device connected, via a suitable communication link, to a computing device operating this module. In one embodiment, the master controller can store desired light generation sequences for subsequent use during operation of the lighting system. The memory device can be configured as an electrically erasable programmable read only memory (EEPROM), electrically programmable read only memory (EPROM), non-volatile random access memory (NVRAM), read-only memory (ROM), programmable read-only memory (PROM), flash memory or other non-volatile memory for storing data. The memory can be used to store data and control instructions, for example, program code, software, microcode or firmware, for monitoring or controlling various devices coupled to the computing device and that can be provided for execution or processing by the CPU.

It will be appreciated that the master controller may provide external input to the lighting system's various lighting devices via direct communication with each device's slave control unit, or via indirect communication, for example, via one or more intermediary communication devices and/or I/O modules. In the latter embodiments, the I/O module may be configured to provide instructions to a slave control unit of a given lighting device, wherein the I/O module is configured, for example, as a communication port. A communication port can be configured to receive and send information in one or more of a plurality of communication protocols, which may include for example, DMX, DALI, RS-485, I2C, RS-232, Ethernet, a proprietary protocol or other communication protocol as would be readily understood by a worker skilled in the art.

In another embodiment, the external input may be provided via an I/O module configured as a user interface integrated within or remote to one or more of the lighting system's various lighting devices, or again, provided by a central control device, such as via a master control module, as described above. Such an I/O module may thus allow a user to directly control the output of a given lighting device, or again provide control instructions to a plurality of lighting devices within a lighting system. Examples of such I/O modules may include, but are not limited to, integrated or distributed hardware architectures comprising, for example, a slide switch, a control panel, a set of buttons and/or other such control interfaces readily known in the art.

### Control Interface(s)

The lighting system, and lighting devices thereof, may be controlled using a number of control methods and protocols. For example, and in accordance with different embodiments of the invention, the system may be appropriately configured for control by various manual controls, standard control protocols and/or proprietary control protocols, to name a few. It will be appreciated by the person of ordinary skill in the art that other control methods and/or protocols may be considered herein to describe different firmware architectures applicable in the present context, without departing from the general scope and nature of the present disclosure.

Therefore, in accordance with some embodiments of the invention, the drive and control system of each lighting device (e.g. system 1020 of FIG. 22) generally comprises one or more control interface modules configured to receive one or more external control inputs from an external source, or from an integrated control interface, and convert same in accordance with a predetermined internal control protocol. Once converted, the control signal is communicated to an integrated or distributed light generation module (e.g. via a dedicated, shared and/or proprietary network) configured to interpret this signal to control light generation from one or more light-emitting elements operatively coupled thereto.

It will be appreciated by the person of skill in the art that an integrated or combined control/light generation module will combine the functions of both modules into a single component, such as a hardware module or the like, as depicted by the integrated modules 117, 317, 417, 617, 917 of FIGS. 2, 4, 5, 7 and 11 respectively.

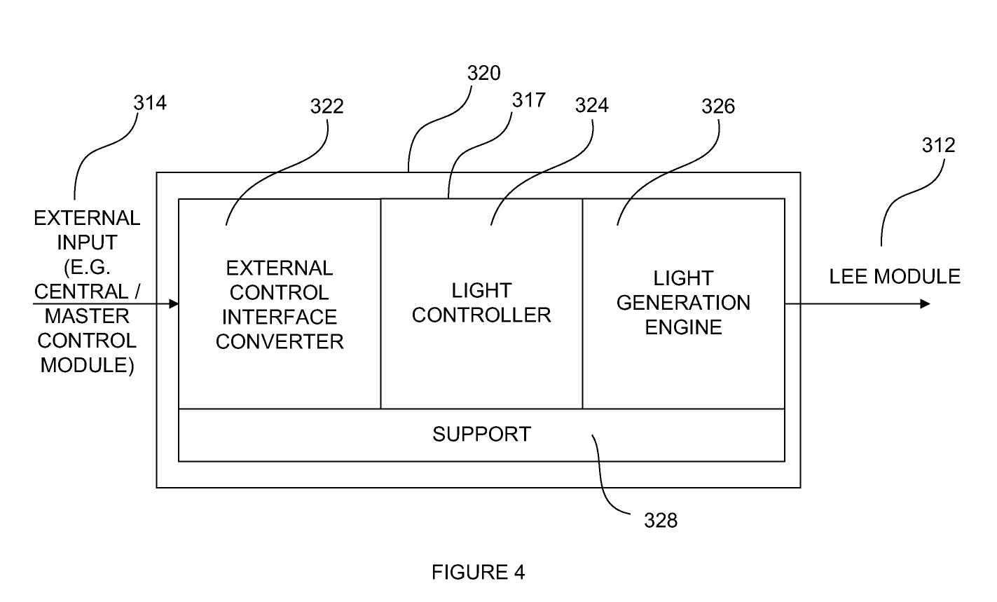

In one embodiment, the control interface module will generally comprise an external control interface conversion (ECIC) component (e.g. see ECIC 322, 422, . . . 922 of FIGS. 4 to 9 and 11), generally acting as a client for an external lighting control protocol or local control interface. The control interface conversion component will generally convert light control commands received from the external interface into an internal representation used within the system, i.e. in accordance with a predetermined internal control protocol.

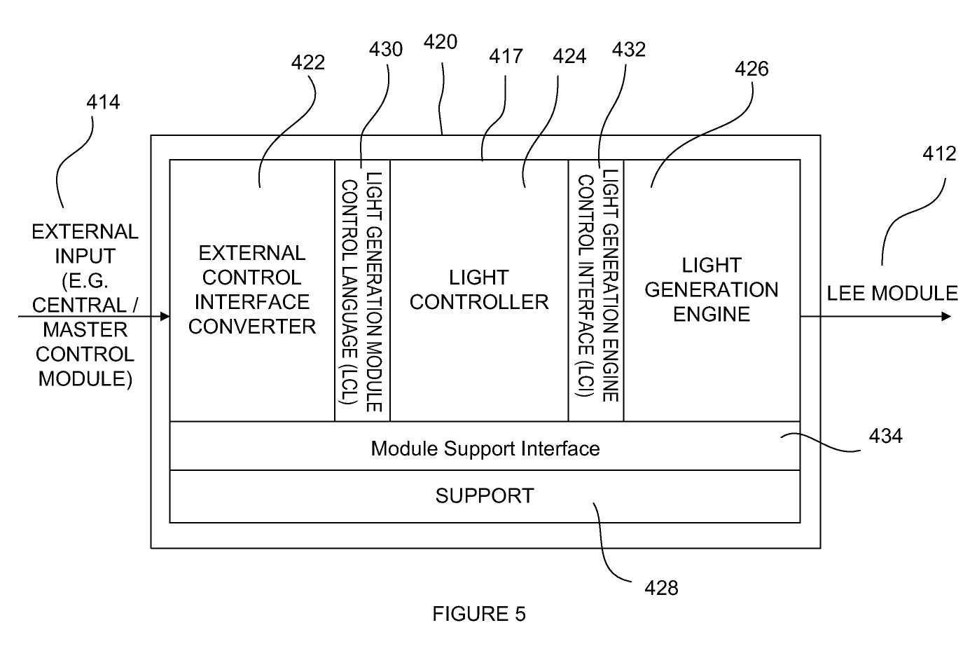

For example, in one embodiment, the converter translates the control commands received into a Light generation module Control Language (LCL—e.g. see LCL 430, 530, . . . 930 of FIGS. 5 to 11), which comprises the syntax of the interface to a light controller (e.g. see light controller 324, 424, . . . 924 of FIGS. 4 to 8, 10, 11) of the light generation module (discussed below), such that the ECIC serves as the master of the LCL conversation. For instance, the LCL may provide a standardised set of commands and queries that allows the ECIC to control and monitor downstream generation and/or control/light generation modules. In one example, the LCL is implemented as an Application Layer (Level 8) protocol in the ISO networking model and is a Master/Slave messaging protocol that may act as an interface protocol to a light generation engine (LGE, discussed below—e.g. see LGE 326, 426, . . . 926 of FIGS. 4 to 8, 10, 11), which comprises the syntax of the interface to a light controller (e.g. see light controller 324, 424, . . . 924 of FIGS. 4 to 8, 10, 11) and allow for control of the output of the LGE.

In one embodiment, a different ECIC is provided for each type of external control network or interface that is to be implemented.

In another embodiment, a same ECIC may be used for two or more types of external control network or interface, either by automatically detecting the type of external input or by providing a selector (e.g. hardware switch, graphical user interface switch, etc) for selecting an appropriate conversion from a list of available conversions.

For example, in one embodiment, the control interface module of a given slave control unit may be configured to detect changes in the control protocol being used by a master controller. The master controller may be changed from supplying information using one standard protocol to another or alternatively to a proprietary protocol for example. Alternatively, one master controller may be replaced by another master controller of a different type.

In one embodiment, the slave control unit can operate in proprietary protocol mode, namely configured to use a proprietary protocol for control thereof, and if a message is not received at the control interface module from the master controller for a predetermined time period, the slave control unit reverts to an alternate standard protocol mode of operation, for example it may default to DMX.

In another embodiment of the invention, when operating in a standard protocol mode, if the information being received for a predetermined period of time from the master controller is not in a format compatible with the standard protocol, the control interface module of the slave control unit will revert to the proprietary protocol.

Other such examples should be apparent to the person of skill in the art and are therefore not meant to depart from the general scope and nature of the present disclosure.

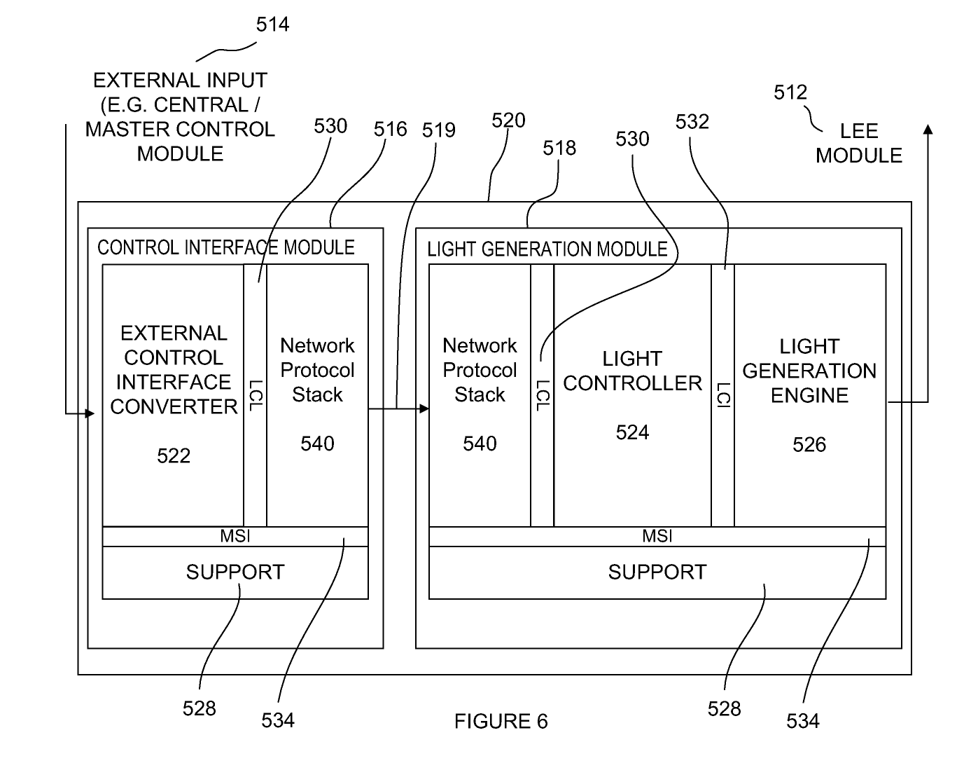

The control interface module may further comprise a networking module, such as a network protocol stack (e.g. see protocol stack 540, 640, 740, 840 and 940 of FIGS. 6 to 11), to provide for a distributed architecture, for example a slave control unit distributed over two or more platforms. Such embodiments may provide for greater versatility allowing the creation of a network of distributed products.

In the embodiment of FIG. 6, for example, the ECIC 522, instead of being interfaced directly to the light controller 524 of the light generation module 518, the LCL 530 is instead passed to the network stack 540 configured to deliver it to the light generation module 518 via a cooperative network stack 540, which is configured to interface with the light controller 524 and downstream LGE 526. It will be appreciated that the network stack may comprise various network stacks known in the art to comprise the necessary firmware required to interface to a private, shared and/or proprietary network, such as network 520 of FIG. 6.

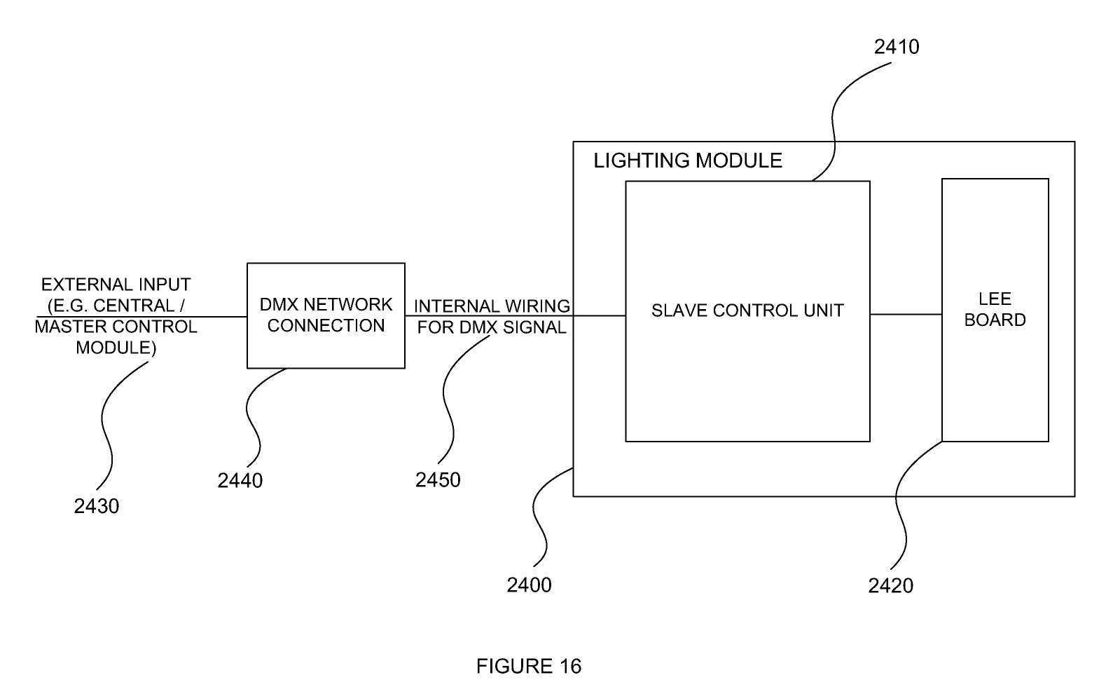

It will be appreciated by the person of ordinary skill in the art that various hardware and/or firmware architectures and configurations may be considered to implement the above-described control interface functions. For instance, as introduced above, different lighting devices, for example configured for operation within different types of lighting system configurations, may be designed to operate in response to an external input received from one or more different types of control interfaces/protocols. The following describes, with reference to FIGS. 13 to 15, some examples of hardware and firmware architectures useable in the present context for controlling a lighting device via a manual control interface, a standard control protocol and a proprietary control protocol, for example. Examples 5 to 8, described further below with reference to FIGS. 16 to 21, provide further examples of control and drive system architectures. It will be appreciated by the person of ordinary skill the art that other such architectures may be considered herein, for instance providing different control interface communications and implementations, without departing from the general scope and nature of the present disclosure.

### Manual Control Interface

In one embodiment where manual control is provided, the lighting system can be controlled with a button, slide, switch or the like configuration of a manual interface. A manual control interface can be operatively coupled to a slave control unit, and thus provide instructions thereto for the operation of the light-emitting element module and thus controlling the light output by the lighting system. The slave control unit is operatively coupled to a set of instructions or firmware (e.g. control interface module) which provides a means for the slave control unit to convert the inputs from the manual interface into appropriate instructions for transmission to the light-emitting element array module.

In one embodiment, the lighting system is controlled using a 4-button interface 2100 as illustrated in FIG. 13. The interface 2100 is operatively coupled to the slave control unit 2125 which is coupled to a light-emitting element board 2130 (e.g. LEE module). The operative coupling of these components can be provided by internal wiring or contacts or the like. Having particular regard to a 4-button interface, in this configuration two buttons can enable manual selection of a preset, wherein the two buttons can enable scrolling in a forward or reverse direction through the one or more presets which can be associated with the slave control unit. The other two buttons can be configured to enable adjustment of the luminous flux output of the solid-state lighting system, for example the increase or decrease of the luminous flux output.

In one embodiment of the invention, the four button interface can interpret the button depressions to produce a DMX output for the control of the slave control unit. Alternately, a DALI interface can translate the protocol from the DALI input to a DMX output. Depending on the configuration of the slave control unit, different protocol pairs can be converted as required, including proprietary protocols.

In one embodiment of the invention, a manual interface can be used to generate and/or define one or more presets for subsequent transmission to the slave control unit for activation of the light-emitting element array module.

In another embodiment of the invention, a manual interface can be used to merely select predefined presets. In this case, a preset fabrication mechanism can be employed in order to generate one or more presets for subsequent storing in the manual interface or the slave control unit for subsequent manual selection. A preset fabrication mechanism can further provide a means for modification of existing presets.

In one embodiment of the invention, as illustrated in FIG. 13, a synchronization interface 2105 can be coupled to the slave control unit 2125, wherein the synchronization interface can provide timing signals which enable the operation of this particular slave control unit to be synchronized with other slave control units, thereby enabling a desired illumination design to be created by a two or more light generation modules.

In one embodiment of the invention a preset can be defined by the following properties:
Step number;
u′v′ Color or xy Color, RGB Color or CCT;
Intensity 0%->100% Encoded into 255 steps;
Intensity Fade Duration 0-65,000 Seconds with resolution of 1 second;
Time to fade from previous step intensity to specified intensity
Chromaticity Change Duration 0-65,000 Seconds with resolution of 1 second
Time to transition from previous step chromaticity to specified chromaticity
Total Duration 0-65,000 seconds, (0=infinite), must be greater than or equal to larger of the fade times.

In one embodiment of the invention, a lighting module and in particular the slave control unit can be configured to store a predetermined number of presets. As would be readily understood, the number of presets that can be stored by a lighting module in proportional to the number of parameters of a particular preset and the amount of memory associated with the slave control unit.

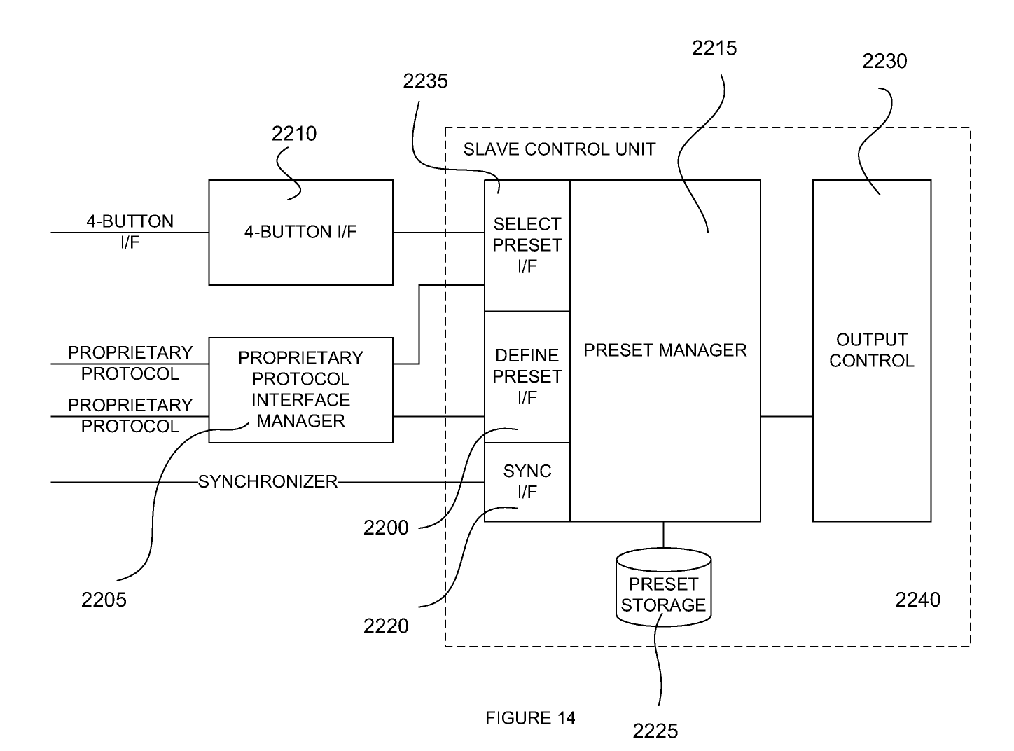

FIG. 14 illustrates a system architecture for a manual control interface according to one embodiment of the invention. The Preset Manager 2215 is a firmware control interface module that implements the presets. The preset manager 2215 provides three interfaces for use of the other firmware modules. The Select Preset Interface 2235 allows the selection of a preset for display as well as the setting of the master intensity for the preset, wherein this interface is operatively coupled to the manual interface manager 2210.

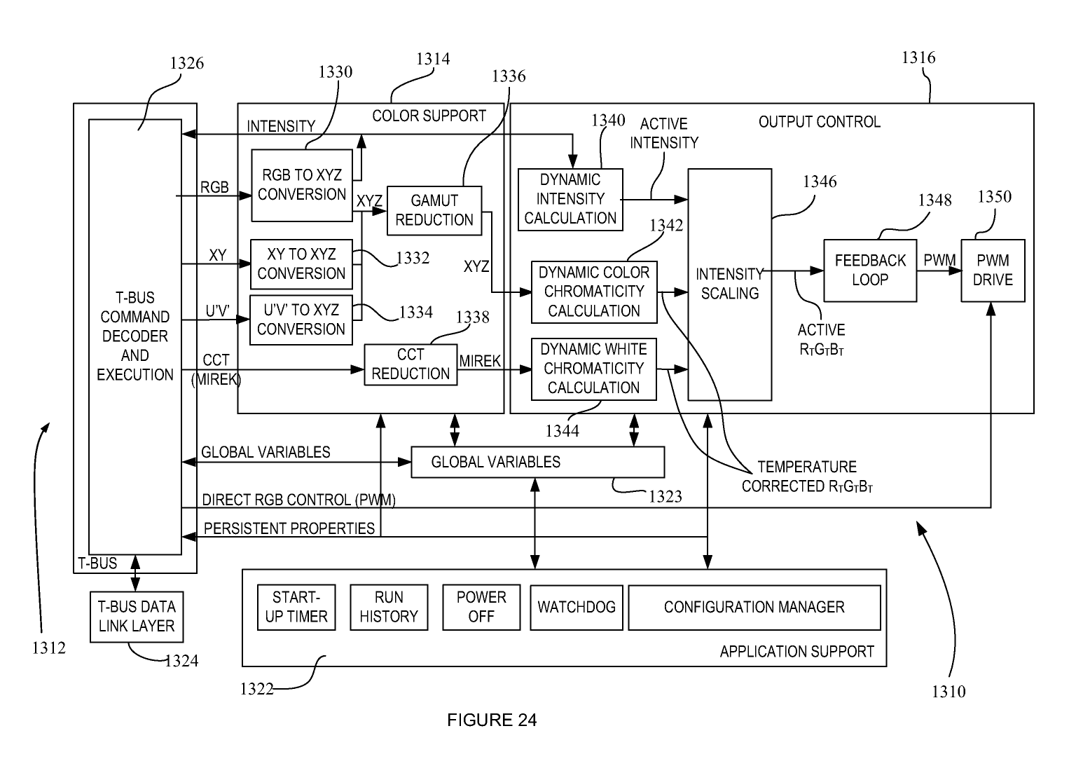

The Define Preset Interface 2200 allows presets to be downloaded and stored by the lighting module. The Sync Interface 2220 interfaces with an external synchronizer module that provides an accurate timing signal, which may be derived from the power line frequency for example, wherein this timing signal can be used to provide accurate timing for dynamic presets. The Output Control 2230 is the main light control firmware of the lighting module, which is operating on the slave control unit (e.g. a component of a LGM, described below; see example embodiment thereof in FIG. 24, as described in Example 9).

In one embodiment, if a solid-state lighting system comprises a plurality of lighting modules which are executing dynamic presets, synchronization of the operation of the plurality of lighting modules may be required. The synchronization interface can supply an accurate timing signal to the slave control unit interface. This synchronization signal can be used to perform all timing of the display of the dynamic preset by the plurality of lighting modules. In one embodiment of the invention, a configuration utility is used to configure a slave control unit with the expected frequency of the synchronization interface, and thus it can be applicable with varying power supply modules, for example, power supply modules which operate at 50 Hz or 60 Hz.

In one embodiment, when the solid-state lighting system is operating in manual control there is no network communication between for example the multiple lighting modules within the system. In this configuration, the operation of the plurality of lighting modules may become unsynchronized. The operative coupling of a synchronization module to the slave control unit of each lighting module of the solid-state lighting system can maintain synchronization of operation thereof.

In one embodiment of the invention, the synchronization module can be physically located on the same printed circuit board as the manual control interface, thereby enabling the reduction of the number of connectors for the slave control unit.

In one embodiment of the invention, the synchronization module is configured to convert 50/60 Hz power line signal into a 50/60 Hz 0 to 3.3V DC digital signal.

In one embodiment of the invention, when a lighting module is operating using a manual control interface, upon application of power to the lighting module, the preset and luminous flux output selected at power down will be the active values upon initial power up. In another embodiment, if the previously selected preset comprises a plurality of steps, the slave control unit is configured to commence generation of control signals based on the first step of the selected preset, wherein these control signals are for subsequent transmission to the light-emitting element array to which the slave control unit is operatively coupled.

It will be appreciated by the person of ordinary skill in the art that the above provides a non-limiting example of a manual control interface, and that other such examples, for instance as described below, may be considered herein without departing from the general scope and nature of the present disclosure.

### Standard Protocol Control

A standard protocol control interface can be employed when the presets which are desired to be performed by the lighting module are complex and these complex presets may not be appropriately controlled using a manual control interface. For example a standard protocol can be DALI, DMX or other standard protocols as would be readily understood by a worker skilled in the art. In one embodiment, the master controller is configured to be a standard protocol controller, for example a DMX controller or a DALI controller.

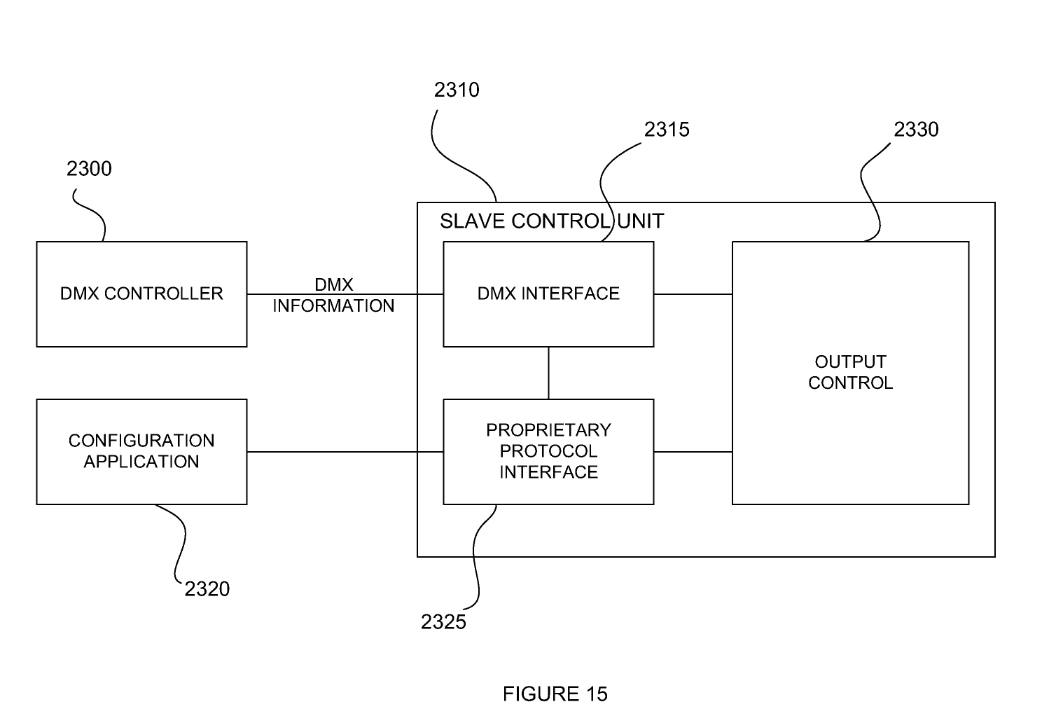

For example, FIG. 15 illustrates a logical architecture for a standard protocol control interface according to one embodiment of the invention, wherein the standard protocol is selected to be DMX. A DMX controller 2300, transmits DMX information to a DMX interface 2315 associated with the slave control unit 2310, which subsequently transmits the received information to an output control module 2330 (e.g. a component of a LGM, described below; see example embodiment thereof in FIG. 24, as described in Example 9), which is configured to generate appropriate control signals, based on the DMX information, wherein these control signals are transmitted to the light-emitting element array module to which the slave control unit is operatively connected.

In one embodiment of the invention, when operating using a standard protocol, the slave control unit can optically monitor the solid-state lighting system in order to determine if control commands have been received which are configured using a proprietary protocol. For example, in this configuration, upon receipt of a proprietary protocol command, the slave control unit can be configured to respond to these proprietary protocol commands using a specified command set. For example, this command set can provide a means to assign a standard protocol address, for example a DMX address and optionally this command set can provide a means for loading one or more presets into memory associated with the slave control unit.

In one embodiment of the invention, a slave control unit can be configured with external connecting switches which can provide a means for setting a standard protocol address for association with the particular slave control unit.

In one embodiment, an implementation of the standard protocol control interface can use a Lightolier Color FX control device, wherein this format of control device can provide information to the slave control unit which can define: xy control parameters for high quality colour control, CCT control parameters for high quality white light control and DMX sync messages for synchronizing dynamic presets being displayed by a plurality of lighting modules.

In one embodiment, a DMX interface is used and this interface is configured to receive DMX frames as defined by USITT DMX512/1990 Digital Data transmission Standard for Dimmers and Controllers, “Recommended Practice for DMX512” by Adam Bennette, PLASA, 1994, herein incorporated by reference, or other such standards, as will be appreciated by the person skilled in the art.

In one embodiment of the invention, the slave control device is configured to interpret a standard protocol format of instruction information, for example DMX protocol, DALI protocol, and convert this format of instructions into a proprietary protocol set of instructions, which are compatible with the operation of the solid-state lighting system.

In one embodiment of the invention, a protocol converter is configured as a Multiple Interface Board (MIB), which is configured to translate a standard protocol into a proprietary protocol.

It will be appreciated by the person of ordinary skill in the art that the above provides a non-limiting example of a standard protocol control interface, and that other such examples, for instance as described below, may be considered herein without departing from the general scope and nature of the present disclosure.

### Proprietary Protocol Control

In one embodiment, the operation of the lighting module is controlled using a proprietary protocol control.

FIG. 14 illustrates a system architecture associated with a proprietary protocol control interface as it would be operatively coupled to a slave control unit 2240. The proprietary protocol interface manager 2205 is operatively coupled to the select preset interface 2235 and the define preset interface 2200, which provides instructions to the preset manager 2215 which manages the saved presets in the preset storage 2225, wherein the selected preset is subsequently transmitted to the output control 2230 of the slave control unit 2240 (e.g. a component of a LGM, described below; see example embodiment thereof in FIG. 24, as described in Example 9). The preset manager 2215 provides three interfaces for use of the other firmware modules. The select preset interface 2235 allows the selection of a preset for display as well as the setting of the master intensity for the preset, wherein this interface is operatively coupled to the manual interface manager 2210. The Define Preset Interface 2200 allows presets to be downloaded and stored by the lighting module. The Sync Interface 2220 interfaces with an external synchronizer module that provides an accurate timing signal, which may be derived from the power line frequency for example, wherein this timing signal can be used to provide accurate timing for dynamic presets. The Output Control 2230 is the main light control firmware of the light generation module which is operating on the slave control unit.

FIG. 15 illustrates a logic architecture of a proprietary protocol interface according to one embodiment of the invention. The configuration application 2320 can provide a means for managing lighting module addresses and presets and can use a RS-485 network or the like, while using a proprietary protocol for example. The proprietary protocol interface 2325 is an interface resident on the slave control unit 2310 and is configured to receive and implement the one or more commands received using the proprietary protocol. The output control module 2330 receives these commands and is configured to generate appropriate control signals, based the received information, wherein these control signals are transmitted to the light-emitting element array module to which the slave control unit is operatively connected.

In one embodiment of the invention, and with reference to FIG. 14, the proprietary protocol interface manager 2205 is a firmware interface that accepts decodes and executes commands via the proprietary protocol. The manual controls and presets can accept commands from both an operational command set, in order to select a preset and an intensity or can accept commands from the configuration command set which allows one or more presets to be downloaded and stored into the non-volatile preset storage 2225 of the lighting module, namely the slave control unit.

In one embodiment of the invention, a proprietary protocol interface can be used for two different types of control for the lighting module. The first control type is power line control, where a solid-state lighting system is controlled using a power line control protocol. The commands can be tailored according to the functionality of a particular lighting module and could include commands for setting output, for example chromaticity and intensity, in addition to the selection of presets, which define controlling intensity, chromaticity and synchronizing output between lighting modules of the solid-state lighting system. The format of the communication capabilities which are required can be determined by the features defined for the slave control unit. The second control type is advanced manual control, where a lighting module is controlled using manual controls attached to an intelligent module. This intelligent module can be interfaced to the slave control unit using a proprietary protocol communications interface which can provide sufficient features for a rich manual interface. In this configuration the proprietary protocol can be used to communicate between the manual control interface module and the slave control unit. The commands can be tailored according to the functionality of that manual control interface module and can include commands for setting output, for example chromaticity and intensity, and for the selection of one or more presets which can include definitions regarding controlling intensity and chromaticity, in addition to the creation, editing and saving of presets for use with the solid-state lighting system.

In one embodiment of the invention, the configuration application can be configured to use the proprietary protocol for communication with the slave control unit creating and configuring the one or more presets associated with the slave control unit. For example, the configuration program can allow a user to load and save one or more presets on the slave control unit, for example in the preset storage. The configuration program can provide a means for editing of the one or more presets by defining a step and linking the selected step with a particular preset number. The configuration application can be used for setting a frequency of a synchronizer module which can provide a means for synchronizing the activities of a plurality of lighting devices within a solid-state lighting system. The configuration application can further provide a means for assignment of a particular name or number to a particular preset, thereby enabling selection thereof in a more simple manner.

It will be appreciated by the person of ordinary skill in the art that the above provides a non-limiting example of a proprietary protocol control interface, and that other such examples, for instance as described below, may be considered herein without departing from the general scope and nature of the present disclosure.

### Light Generation Module

The drive and control system of each lighting device (e.g. system 1020 of FIG. 22) generally comprises one or more light generation modules configured to communicate with one or more control interface modules and access therefrom control commands and/or instructions, converted by the latter in accordance with an internal control protocol, and interpret these commands to operate one or more light-emitting element modules operatively coupled thereto. In general, the light generation module generates and controls light output in keeping with commands received from a manual, standardized and/or proprietary control interface. In one embodiment, the light generation module comprises a hardware module that generates and controls light output from the one or more light-emitting element modules.

In one embodiment, the control interface module will generally comprise a light controller (LC—e.g. see light controller 324, 424, . . . 924 of FIGS. 4 to 8, 10, 11) and a light generation engine (LGE—e.g. see LGE 326, 426, . . . 926 of FIGS. 4 to 8, 10, 11). The LC generally comprises a firmware component that implements a standard set of high level light control functions. These may include, but are not limited to, mapping between different colour spaces, managing transitions of intensity and chromaticity in the light output and managing the colour gamut, for example. In one embodiment, the functions implemented in the LC are those that are independent of the actual light generation hardware being controlled.

The LGE generally implements the firmware responsible for the low level control of the light generation hardware and algorithms, for example, a firmware component within a light generation module that provides the direct control over the light generation capabilities of the light generation module and light-emitting element module(s) operatively coupled thereto.

In one embodiment, the LC serves as a LCL client, implementing the commands required by LCL provided from the control interface module. It may also serve as the master of the conversation with the LGE using a Light Generation Engine Control Interface (LCI—e.g. see LCI 432, 532, . . . 932 of FIGS. 4 to 8, 10, 11), which may be configured to provide a high performance and tightly coupled interface to allow the LC to provide to the LGE the chromaticity and intensity of the light to be generated. In one example, it is implemented as a group of variables that may be changed by the LC and are used by the LGE to control its output.

Conversely, the LGE is a client to the LC using the LCI. The LGE accepts the commands received on the LCI and, using the control algorithms implemented within the LGE, controls the underlying hardware to produce the required light output via the one or more light-emitting element modules.

The light generation module may further comprise a networking module, such as a network protocol stack (e.g. see FIGS. 6 to 11) to provide for a distributed architecture. Such embodiments provide for greater versatility allowing the creation of a network of distributed products.

In the embodiment of FIG. 6, the ECIC 522, instead of being interfaced directly to the light controller 524 of the light generation module 518, the LCL 530 is instead passed to the network stack 540 configured to deliver it to the light generation module 518 via a cooperative network stack 540, which is configured to interface with the light controller 524. It will be appreciated that the network stack may comprise various network stacks known in the art to comprise the necessary firmware required to interface to a private, shared and/or proprietary network, such as network 520.

In Example 9 below, with reference to FIG. 24, a detailed example of a lighting module application, and of the various light generation module components thereof, is described. Namely, the various functional components of the output control application 1316 may be operated to provide a controlled output consistent with an external input received, for example, from a master control module, an integrated or remote I/O module, and converted in accordance with a predefined internal protocol by the various functional components of the T-BUS 1326 and Color Support applications 1314.

It will be appreciated by the person of ordinary skill in the art that the above and the following examples provide non-limiting examples of a light generation module configuration and implementation, and that other such examples may be considered herein without departing from the general scope and nature of the present disclosure.

### Optional Module Support

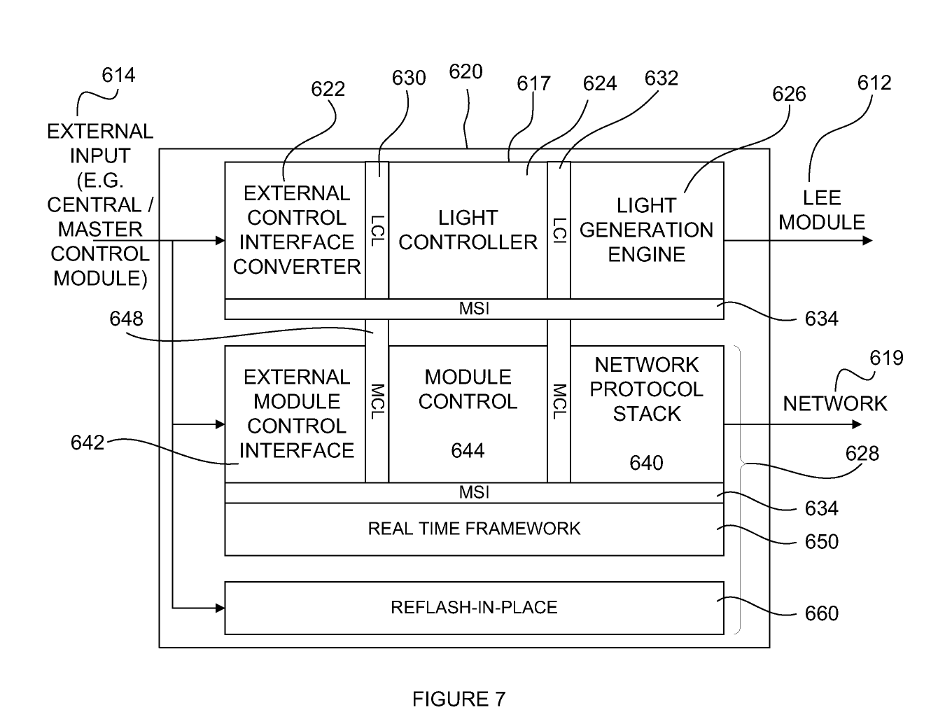

The system may further comprise a module support component (e.g. see support 428, 528, . . . 928 of FIGS. 4 to 11), which may provide features to control the support, configuration and maintenance of the system as well as a real time framework (e.g. see real time framework 650, 750, . . . 950 of FIGS. 7 to 11), a small real time operating system kernel, for example.

In general, a Module Support Interface (MSI—e.g. see MSI 434, 534, . . . 934 of FIGS. 5 to 11) and Module Control Language (MCL—e.g. see MCL 648, 748, . . . 948 of FIGS. 7 to 11) may be used to provide a standardized set of commands and queries that allows for the configuration, maintenance and updating of a type of module in this architecture. In one embodiment, it may be implemented as an Application Layer (Level 8) protocol in the ISO networking model and comprise a Master/Slave messaging protocol.

In one embodiment, if the module is connected to an external control network that is suitable as a transport mechanism for MCL, then an External Module Control Interface (EMCI—e.g. see EMCI 642, 742, . . . 942 of FIGS. 7 to 11) may be used to provide the protocol translation needed to extract the MCL from the external control and interface it to a Module Control (MC) component (discussed below).

In one embodiment, the Module Control (e.g. see MC 644, 744, . . . 944 of FIGS. 7 to 11) is a client for MCL and implements commands to assist with the maintenance and configuration of the module.

A Real Time Framework (FW) may also be provided, in accordance with one embodiment of the invention, to provide a real time kernel which provides multitasking support and a set of standard hardware drivers for the module support.

In one embodiment, a Reflash-in-Place (RP—e.g. see RP 660, 760, . . . 960 of FIGS. 7 to 11) component is also provided, the RP comprising a standalone firmware component used to update the remainder of the firmware in any type of module. For example, the RP may comprise a firmware component of all hardware modules that allows for the re-flashing of the firmware in such modules.

### Light-Emitting Element Module(s)

The system is generally configured to control light generation from one or more light-emitting element modules. In general, a light-emitting element module in the present context may comprise one or more devices that emit radiation in a region or combination of regions of the electromagnetic spectrum, for example, the visible region, infrared and/or ultraviolet region, when activated by the system. Therefore a given light-emitting element module can have monochromatic, quasi-monochromatic, polychromatic or broadband spectral emission characteristics.

In addition, a light-emitting element module, in accordance with different embodiments of the invention, may comprise a specific device that emits radiation and can equally comprise a combination of the specific device that emits the radiation together with a housing or package within or in relation to which the device or devices are disposed. For example, a light-emitting element module may be configured to comprise one or more light-emitting elements, as defined above and optionally combined with one or more luminescent and/or phosphorescent materials disposed so to be stimulated thereby, one or more traditional light sources such as those commonly known in the art, and other such light sources as will be apparent to the person of skill in the art.

For instance, in one embodiment, the one or more light-emitting element modules each comprise one or more light-emitting elements, the combined output thereof being controlled by the lighting system to produce a desired luminous effect. Such luminous effects may include, but are not limited to, one or a combination of a desired chromaticity, output intensity, spectral power distribution, colour quality and/or colour rendering indices (CRI), luminous efficacy, wall-plug efficiency and the like. Luminous effects may further be enhanced by a controlled combination of the output of one or more light-emitting elements with the output of one or more cooperatively controlled traditional light sources, for example.

In another embodiment a light-emitting element module comprises one or more light-emitting element arrays of one or more light-emitting elements. For each array the one or more light-emitting elements can be arranged in a series configuration, parallel configuration or a series/parallel configuration. The one or more light-emitting elements can be selected such that they emit light having a desired chromaticity. As would be readily understood by a worker skilled in the art, the one or more light-emitting elements can be mounted for example on a PCB (printed circuit board), a MCPCB (metal core PCB), a metallized ceramic substrate or a dielectrically coated metal substrate that carries traces and connection pads.

The light-emitting elements can be primary light-emitting elements that can emit colours including blue, green, red or other colours. The light-emitting elements can optionally be secondary light-emitting elements, which convert the emission of a primary source into one or more monochromatic wavelengths, polychromatic wavelengths or broadband emissions, for example in the cases of blue or UV pumped phosphor coated white LEDs, photon recycling semiconductor LEDs or nanocrystal coated LEDs. Additionally a combination of primary and/or secondary light-emitting elements can be employed.

In one embodiment, an array of light-emitting elements having spectral outputs centred on wavelengths corresponding to the colours red, green and blue can be selected, for example. Optionally, light-emitting elements of other spectral output can additionally be incorporated into the array, for example light-emitting elements radiating at the red, green, blue and amber wavelength regions may be configured as the light-emitting element module, or optionally may include one or more light-emitting elements radiating at the cyan wavelength region. The selection of light-emitting elements for the light-emitting element module can be directly related to the desired colour gamut and/or the desired maximum luminous flux and colour rendering index (CRI) to be created by the light-emitting element module, for example.

In another embodiment, a plurality of light-emitting elements are combined in an additive manner such that a combination of monochromatic, polychromatic and/or broadband sources is possible. Such a combination of light-emitting elements includes a combination of red, green and blue (RGB) light-emitting elements, red, green, blue and amber (RGBA) light-emitting elements and combinations of said RGB and RGBA together with white light-emitting elements. The combination of both primary and secondary light-emitting elements in an additive manner is possible. Furthermore, the combination of monochromatic sources with polychromatic and broadband sources such as light-emitting elements generating light having colours RGB and white, GB (green and blue) and white, A (amber) and white, RA (red and amber) and white, and RGBA and white is also possible. The number, type and colour of the multiple light-emitting elements can be selected depending on the lighting application and to satisfy lighting requirements in terms of a desired luminous efficiency and/or CRI, for example.

In another embodiment, the light-emitting elements are electrically connected in series as pairs of linear strings, wherein a string may comprise light-emitting elements from a combination of colour bins of the same generic colour, for example blue, wherein the dominant wavelengths of the light-emitting elements for one of the pair of linear strings are equal to or greater than a predetermined wavelength and the dominant wavelengths of the light-emitting elements of the other string of the pair of strings are equal to or less than this predetermined wavelength. Therefore, by adjusting the relative drive currents to each string of a pair of strings of a given color, it can be possible to dynamically adjust the effective dominant wavelength of that given colour for the light-emitting element array module.

In one embodiment, an array of light-emitting elements is configured with parallel connections of two or more branches of light-emitting elements and thus may additionally require a current limiting device per branch. A current limiting device can comprise a fixed resistor, variable resistor, or transistor, for example, as would be readily understood by a person skilled in the art. The current limiting device can also comprise an operational amplifier (op-amp) operatively coupled to a transistor and a current sensing device positioned within the particular branch. The op-amp can sense the drive current in a branch and adjust the resistance of the transistor such that the drive current remains below a desired maximum. The current limiting device can be calibrated to obtain certain performance characteristics of a branch of light-emitting elements.

### Optics Module(s)

The one or more light-emitting element modules may also comprise, or be optically coupled to, one or more optics modules comprising one or more optical and/or structural components provided to condition the emitted radiation (e.g. with respect to the emitted wavelength, spectral power distribution, intensity, spatial configuration, etc.) as required and/or selected for one or more applications for which the lighting device or system may be used. Examples of structural components may include, but are not limited to, various housing components, mounting and orienting structures, optical masks and the like. Examples of optical components may include, but are not limited to, various lenses, reflectors, diffusers, filters and the like.

The optics module generally receives illumination created by the light-emitting element module and provides a means for efficient optical manipulation of this illumination. The optics module can for example provide a means for the collection and/or collimation of luminous flux emitted by the light-emitting element module and can provide colour mixing of the emission of multiple light-emitting elements. The optics module can also provide control over the spatial distribution of light emanating from the lighting device, or combination thereof in a given lighting system configuration.

The optics module can use a variety of optical elements to produce a desired luminous intensity and chromaticity distribution. The optical elements can include one or more of refractive elements, for example glass or plastic lenses, compound parabolic concentrators (CPC) or advanced modifications thereof such as tailored dielectric total internal reflection optics, Fresnel lenses, GRIN lenses and microlens arrays. The optical elements can also include reflective and diffractive elements, including holographic diffusers and GBO-based mirrors.

In one embodiment, a dielectric total internal reflection concentrator (DTIRC) such as a CPC optical element can be used to collect the emission from a multiplicity of light-emitting elements. It is readily understood that the sectional shape of the concentrator is not limited to parabolic, but can also take the shape for example of a hyperbola, ellipse, trumpet, or a connection of many line segments wherein each segment is designed to meet the optical purpose desired.

In one embodiment, the optics module provides for the creation of an asymmetric illumination beam pattern while additionally mixing the light created by the two or more light-emitting elements. The optics module comprises one or more optical devices each comprising a reflector body which extends between an entrance aperture and an exit aperture, wherein two or more light emitting elements are positioned relative to the entrance aperture and light is reflected within the reflector body exiting at the exit aperture. The reflector body includes a first pair of walls including symmetric reflective elements and a second pair of walls orthogonal to the first pair of walls, wherein the second pair of walls includes asymmetric reflective elements. The first pair of walls provides a means for mixing the light generated by the two of more light-emitting elements and generating a symmetric beam pattern about a first axis. Along a second axis, orthogonal to the first axis, the second pair of walls provides a means for mixing the light generated by the two or more light-emitting elements and generating an asymmetric beam pattern.

In one embodiment, an optics module comprises an entrance aperture, an exit aperture and a light manipulation chamber defined by a substantially square cross sectional reflector body therebetween. The reflector body comprises a first pair of walls, which are symmetrically configured. In one embodiment the first pair of walls are configured as parabolic reflective elements for mixing the light generated by light-emitting element array module. The symmetrically configured parabolic walls further provide for a symmetric beam pattern in a first direction being emitted from the exit aperture of the optical device. Two or more light-emitting elements are positioned proximate to the entrance aperture and light emitted thereby is reflected within the reflector body exiting at the exit aperture. The reflector body further comprises a second pair of walls which are asymmetrically configured. A first wall of the second pair of walls is configured as a parabolic reflective element and the other wall is configured as a planar reflective element, which together provide for the mixing of the light generated by light-emitting element array module. The asymmetrically configured walls further provide for an asymmetric beam pattern being emitted from the exit aperture of the optical device in a second direction.

The invention will now be described with reference to specific examples. It will be understood that the following examples are intended to describe embodiments of the invention and are not intended to limit the invention in any way.

### EXAMPLES

### Example 1

FIG. 7 shows the firmware architecture for an integrated drive and control system 620 comprising a combined control interface/light generation module 617, in accordance with one embodiment of the invention. The module 617 generally comprises an ECIC 622 configured to receive an external input 614 and convert same in accordance with the LCL 630. The converted LCL commands are then communicated to a light controller 624 operatively linked to an LGE 626 via a LCI 632 for generation of a controlled light output via light-emitting element module(s) 612.

In this embodiment, all components other than the ECIC 622 interface directly with the light controller to exchange the needed LCL commands and responses. Access to a private network 619 is optionally provided to allow connection to a distinct control interface module and/or light generation module in order to implement external controls not implemented within the control interface/light generation module 617.

The module further comprises a module support component 628 interfacing with the above components via an MSI 634 and comprising an external module control interface 642 for receiving external module control commands and instructions and communicating same via MCL 648 to a module control component 644, and optionally, to external modules via a network protocol stack 640. A real time framework 650 may also provide multitasking support and a set of standard hardware drivers for the module support 628. A reflash-in-place 660 is also provided in this example to update the firmware, when needed, throughout the module 617.

### Example 2

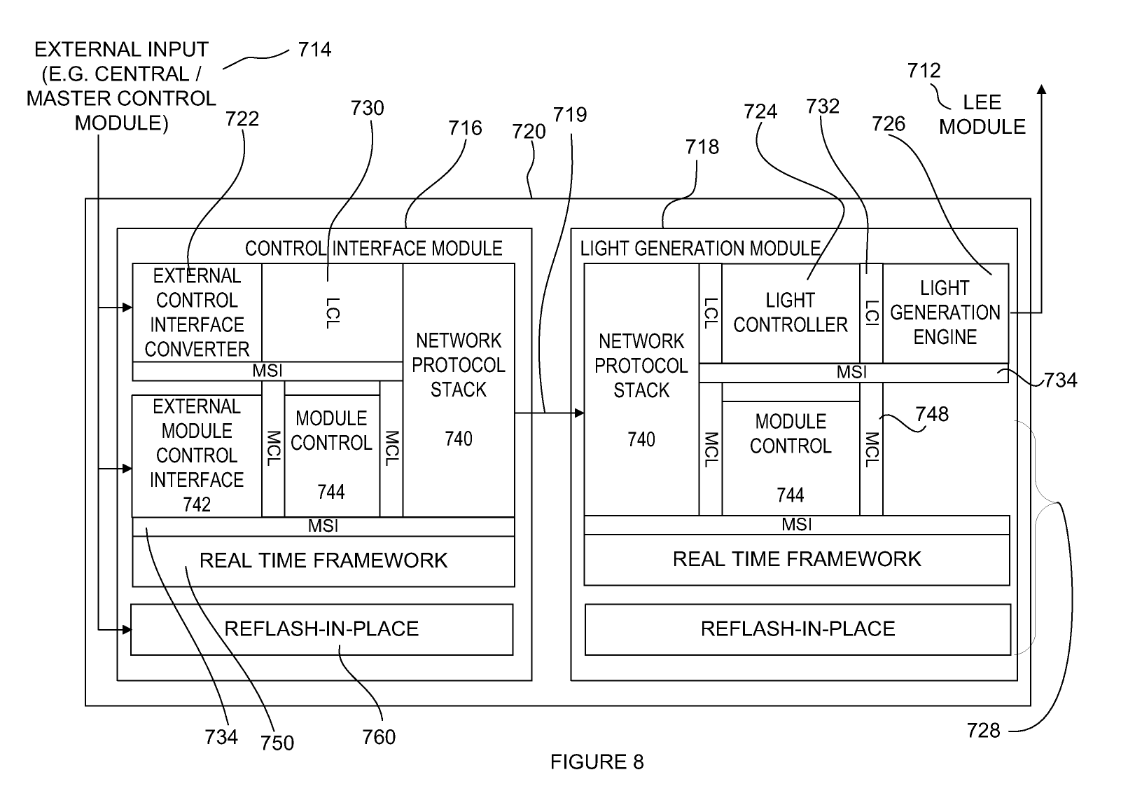

FIG. 8 shows the firmware architecture for a distributed system 720 comprising a distinct control interface module 716 and light generation module 718. In this embodiment, a number of the firmware components are duplicated so that each module 716, 718 comprises its own copy (e.g. network protocol stack 740, module control 744, real time framework 750, reflash-in-place 760, etc.).

In this embodiment, the external input 714 is connected to the ECIC 722 of the control interface module 716, which is responsible for converting this input into LCL 730 and communicate this converted input to the light controller 724 of the light generation module 718 via a private network 719 and appropriate network stacks 740. Once received, the light controller 724, interfacing with a LGE 726 via LCI 732, may then proceed in cooperatively controlling generation of light from the light-emitting element module(s) 712.

As in the above, example, the control interface module 716 and light generation module 718 each comprise a module support 728, the components of which configured to interface with the module components via a MSI 734 and MCL 748, and being distributed accordingly to provide support functions to the respective modules. For instance, an external module control interface 742 is only implemented in the control interface module 716 where it may be needed to interface with an external network or interface. The control interface module 716 and light generation module 718 each however comprise their own module control 744, real time framework 750 and reflash-in-place component 760.

### Example 3

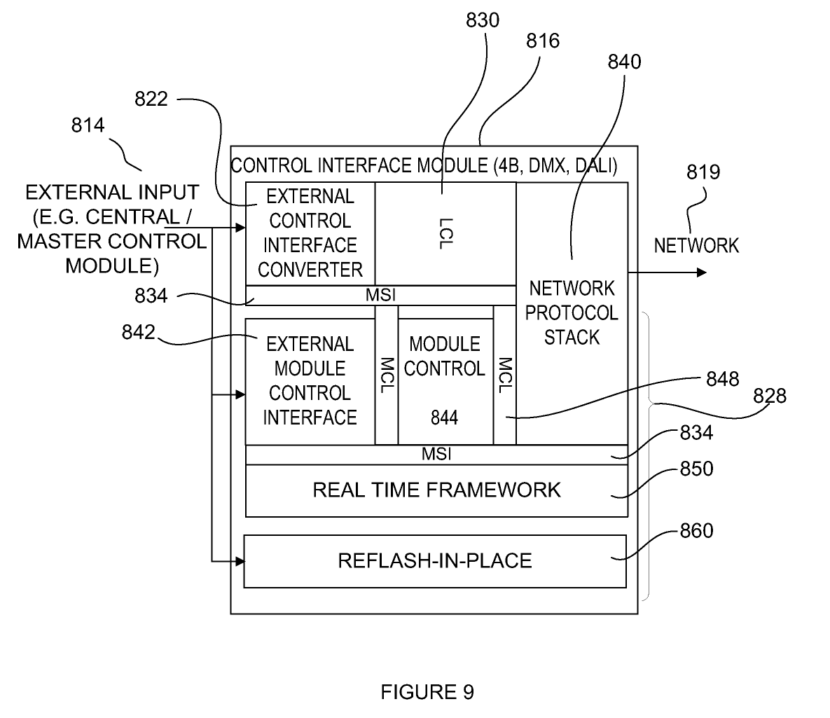

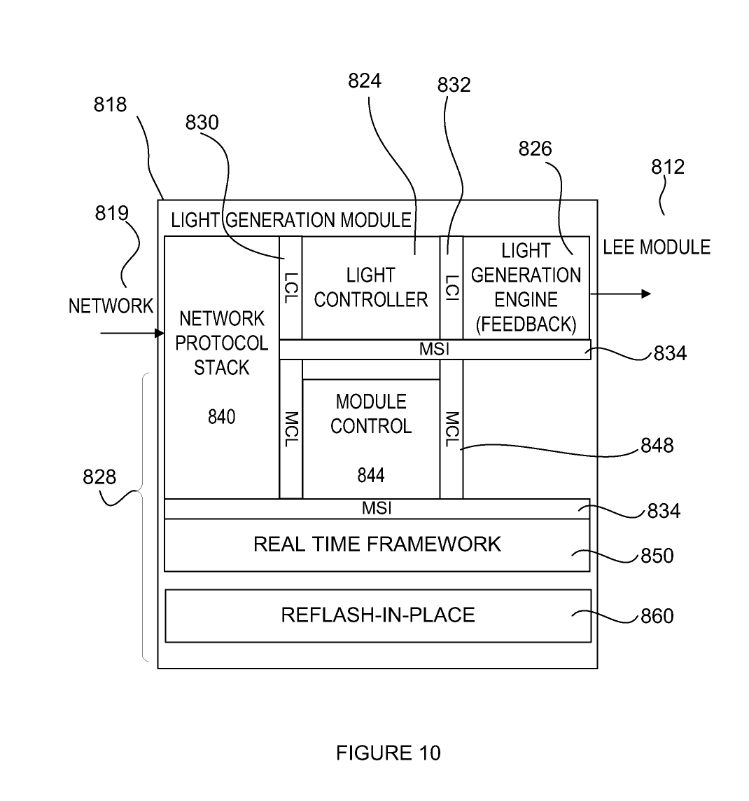

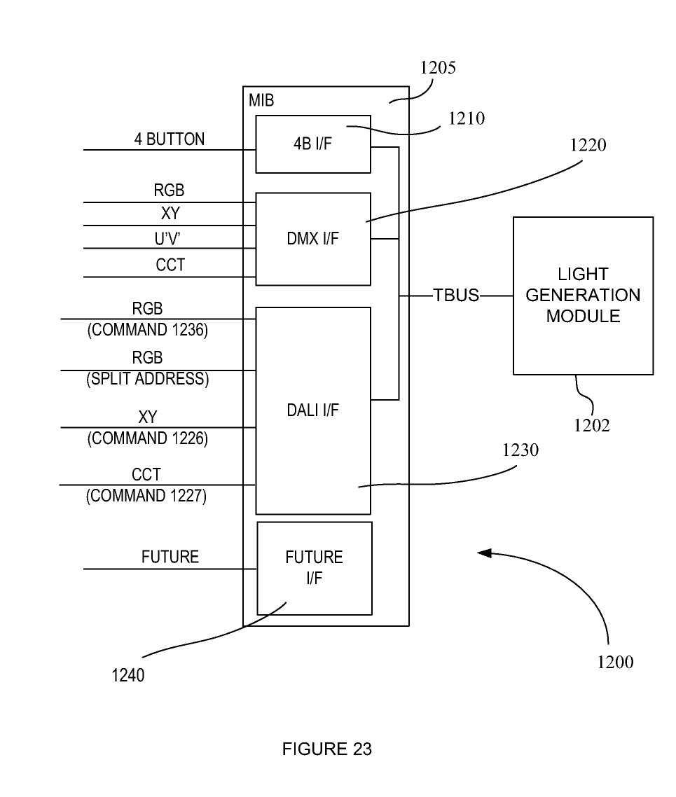

FIGS. 9 and 10 provide an example of a distributed system comprising a control interface module 816 (see FIG. 9) communicatively linked to a light generation module 818 (see FIG. 10) via a private network 819. The control interface module 816 is illustratively comprised of a multiple interface board, which, in this example, can be manufactured to provide one of three options, each one of which supporting a single external input 814: DALI, DMX, or 4-Button Manual Control (e.g. see also Example 8 with reference to FIG. 23).

In this example, the control interface module 816 supports a single private network 819 which may be used to communicate MCL 848 and RP 860 to the control interface module 816, and transport LCL 830, MCL 848 and RP 860 traffic between the ECIC 822, external module control interface 842 and module control 844 of the control interface module 816, and the light controller 824 (and indirectly the LGE 826) and module control 844 of the light generation module 818, via respective protocol stacks 840.

In this example, the light generation engine 826 is also configured to provide feedback control of the light-emitting element module(s) 812 using one or more sensed operating and/or output characteristics thereof (not illustrated).

In this example, the network 819 comprises a point-to-point serial link between the control interface module 816 and the light generation module 818. The DALI and DMX versions of the control interface module 816 may however be configured to allow the communications of RP over the external communications network, for example, using an extended version of the private network protocol to communicate the RP data using a point to multipoint extension thereof.

It will be appreciated by the person of skill in the art that a point to multipoint architecture may also be devised between a single control interface module and plural light generation modules so to provide distributed control of plural light-emitting element modules, or combinations thereof, from a single external input, for example.

### Example 4

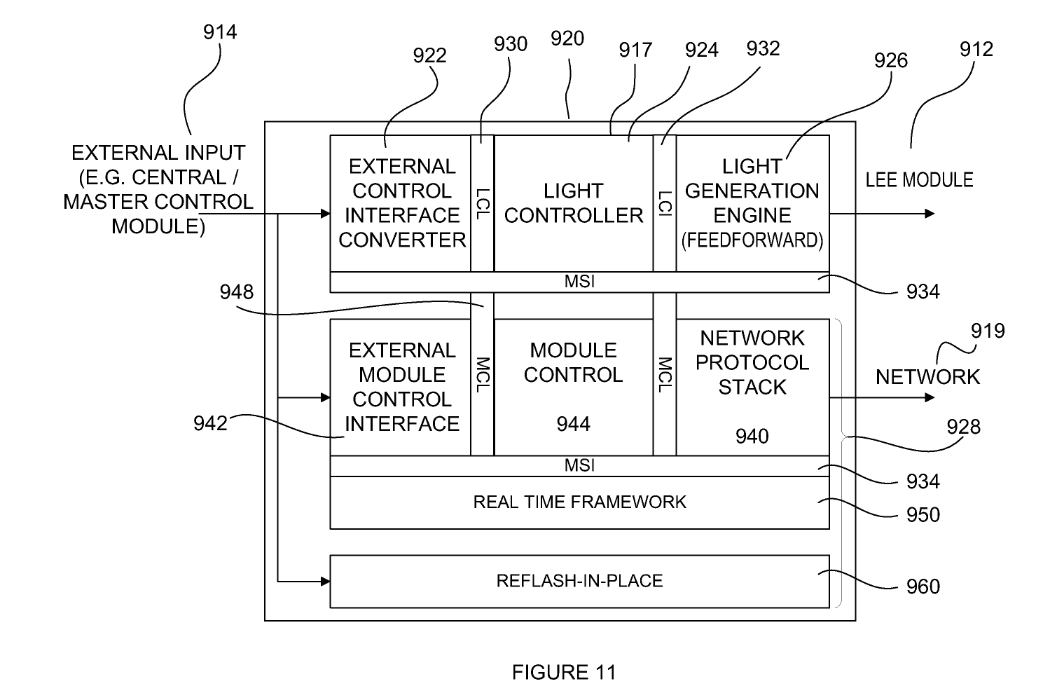

FIG. 11 provides an example of an integrated system 920 comprising a combined control interface/light generation module 917. The combined module 917 is generally configured as the distributed system of FIGS. 9 and 10, however, the interface between the light controller 924 and the external control interface converter 922 is provided integrally without recourse to a network, such as private network 819 of FIGS. 9 and 10 for example. Namely, LCL 930 commands may be communicated directly and integrally between the ECIC 922 and light controller 924 without recourse to a network, as can MCL 948 and RP 960 traffic be communicated via MSI 934 throughout a singular integrated module support 928 and real time framework 950. Access to a network 919 is nonetheless optionally provided such that external commands not implemented by the combined module 917 may be communicated to a downstream module, for example.

In this example, the light generation engine 926 is also configured to provide temperature feedforward control of the light-emitting element module(s) 912.

### Example 5

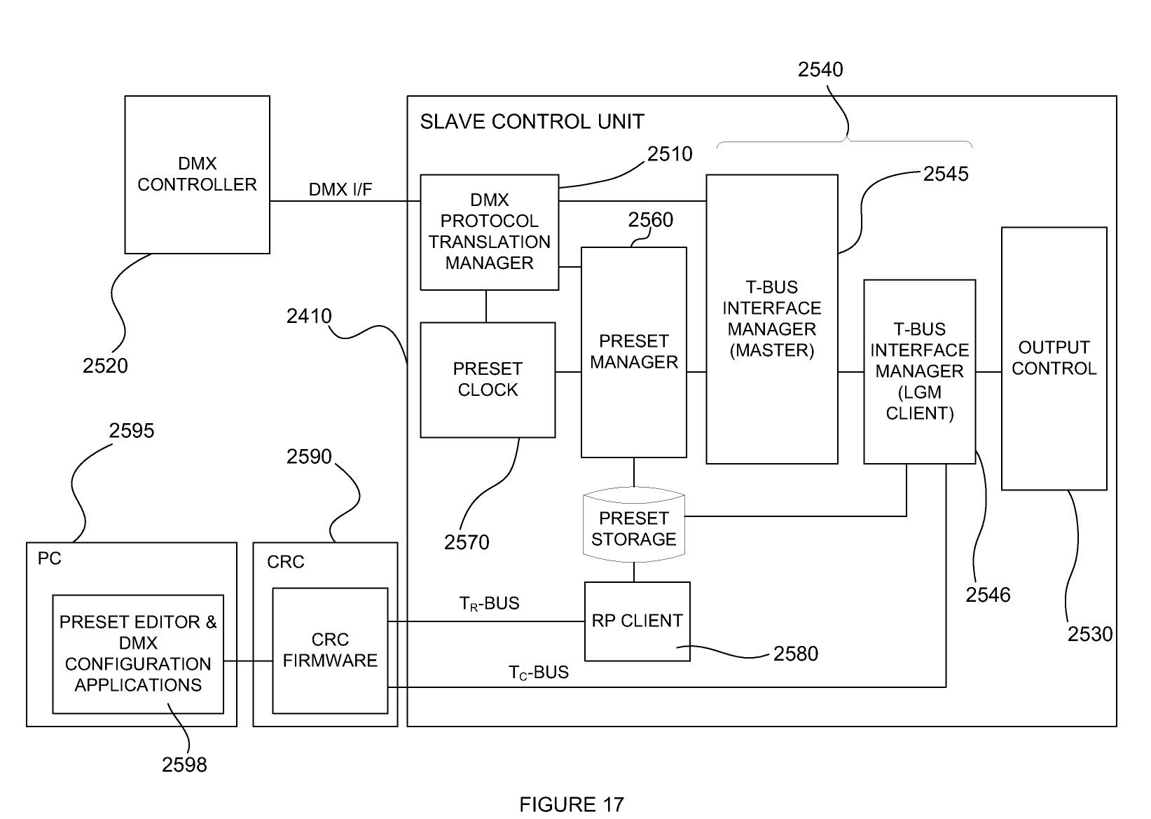

Referring to FIGS. 16 and 17, and in accordance with an example embodiment of the invention, a hardware and firmware architecture of a lighting device/module, and in particular, of a drive and control system thereof, will now be described. With particular reference to FIG. 16, the drive and control system of a lighting module 2400 generally comprises a slave control unit (SCU) 2410 and an attached light-emitting element module 2420 (e.g. LEE board or the like), the SCU 2410 being operatively configured to receive an external DMX input 2430 via an appropriate DMX network connection 2440 and internal wiring 2450. In this embodiment, all the firmware for controlling the output of the lighting modules/device resides on the slave control unit.

The Firmware Architecture of the embodiment in FIG. 16 is illustrated in FIG. 17. It shows how the elements of the firmware architecture are allocated to the various processor resources in the hardware architecture. The DMX Protocol Translation module 2510 (e.g. Control Interface Module) is implemented on the SCU 2410 and is configure to receive external signals from the DMX controller 2520 (e.g. via DMX network connection 2440 of FIG. 16) and communicates a converted version of same with the output control module 2530 (e.g. component of Light Generation Module—LGM) using a T-Bus interconnect system 2540 to issue control commands to the control module 2530. The various components of this architecture may be described as follows.

DMX Protocol Translation Manager 2510: A firmware module that interprets DMX formatted frames and translates the data into T-Bus commands.

T-Bus Interface Manager (Master) 2545: A firmware interface that formats commands for the T-Bus interconnect system 2540 and its communication protocol. Both the DMX Protocol Translation 2510 and Preset managers 2560 use this module to format commands for the output control 2530. The T-Bus may be used to overcome the limitations of DMX and can be used to extend the control functionality or to simplify the complexities of controlling the lighting system. It may utilize the same physical layer or other widely known simplex, half-duplex or full-duplex interconnect systems but utilize a message and command format not available or distinct from DMX. Such message formats may include dedicated addressing schemes and message protocols and support command sets similar to or exceeding those commonly used with DMX. It is noted that there are a wide range of other forms of interconnect systems known in the general art of network data transfer that can be used in, and are suitable for, different embodiments of the invention.

Preset Manager 2560: A firmware control module that implements the preset features.

Preset Clock 2570: The preset clock uses an external time base to correct for a non-synchronous processor clock in order to maintain accurate long duration timing for the Preset Manager 2560.

Re-flash in Place (RP) Client 2580: A stand alone client module (e.g. operates separately from the other firmware on the SCU) that implements commands to update the interface module firmware and to update properties in the EEPROM. The RP Client can accept Tr-Bus commands, according to a subset of commands of the T-Bus.

T-Bus Interface Manager (LGM Client) 2546: A firmware interface that decodes and executes commands via the T-Bus communications protocol. The LGM implementation accepts a rich selection of commands for controlling a LGM.

Output Control 2530: The main light control firmware of the LGM, and example embodiment of which is described in Example 9 with reference to FIG. 24.

CRC Firmware 2590: The Configuration and Re-flash Connector (CRC) is an interface device that can connect between a standard personal computer (PC) communications port and either a DMX or DALI network. It provides applications residing on the PC 2595 with electrical and protocol access to the network and allows those applications to talk to the SCU 2410 using T_{C}-Bus or T_{R}-Bus protocol. Depending on what the application needs to do with the SCU 2410, it can talk using either the T_{C}-Bus protocol to the T-Bus Interface Manager (LGM Client) or using T_{R}-Bus protocol to the RP Client. The application will control the switching between these two modes.

Preset Editor and DMX Configuration Applications 2598: There are several applications that run on a PC that can be used to configure and manage the features on the SCU, as will be appreciated by the person of ordinary skill in the art. For the preset features of the SCU, the applicable application is the Preset Editor, which allows creation and editing of Presets. For the DMX features of the SCU, the DMX Configuration Application is the applicable application. This application allows for the setting of DMX operating parameters including the DMX mode and the DMX address.

DMX Controller 2520: The master device for the DMX network.

The person of ordinary skill in the art will appreciate that the above and other such hardware and firmware modules may be combined and/or interchanged in a number of ways to provide similar effects. Accordingly, such substitutions and/or permutations are not considered to depart from the general scope and nature of the present disclosure.

### Example 6

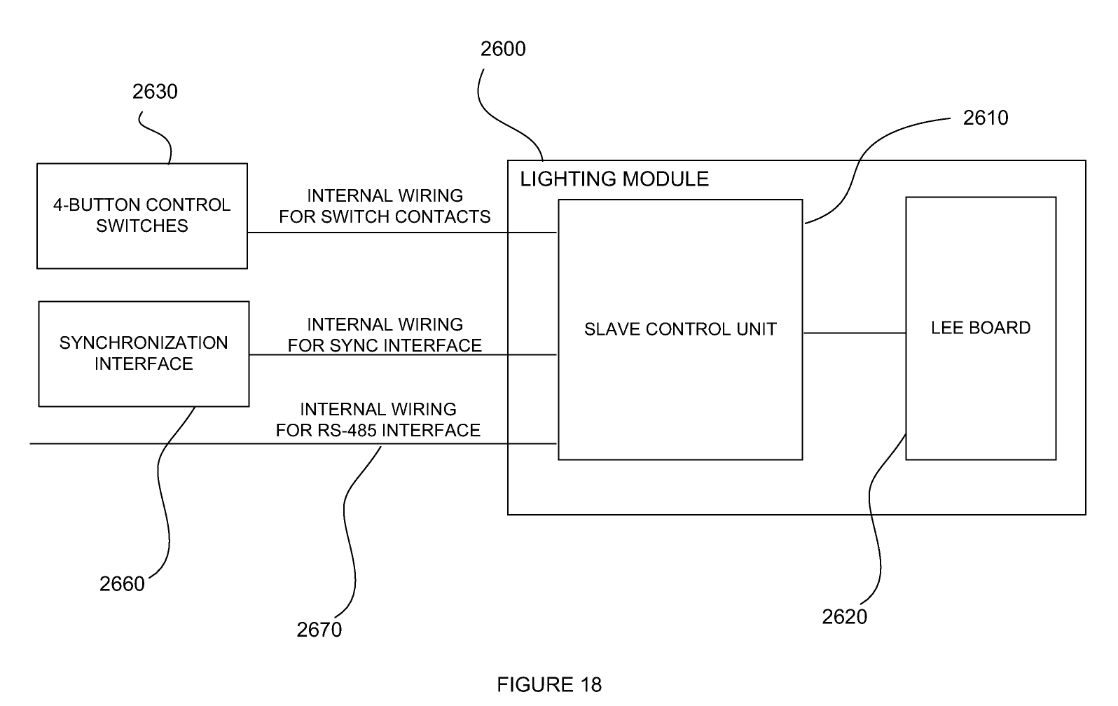

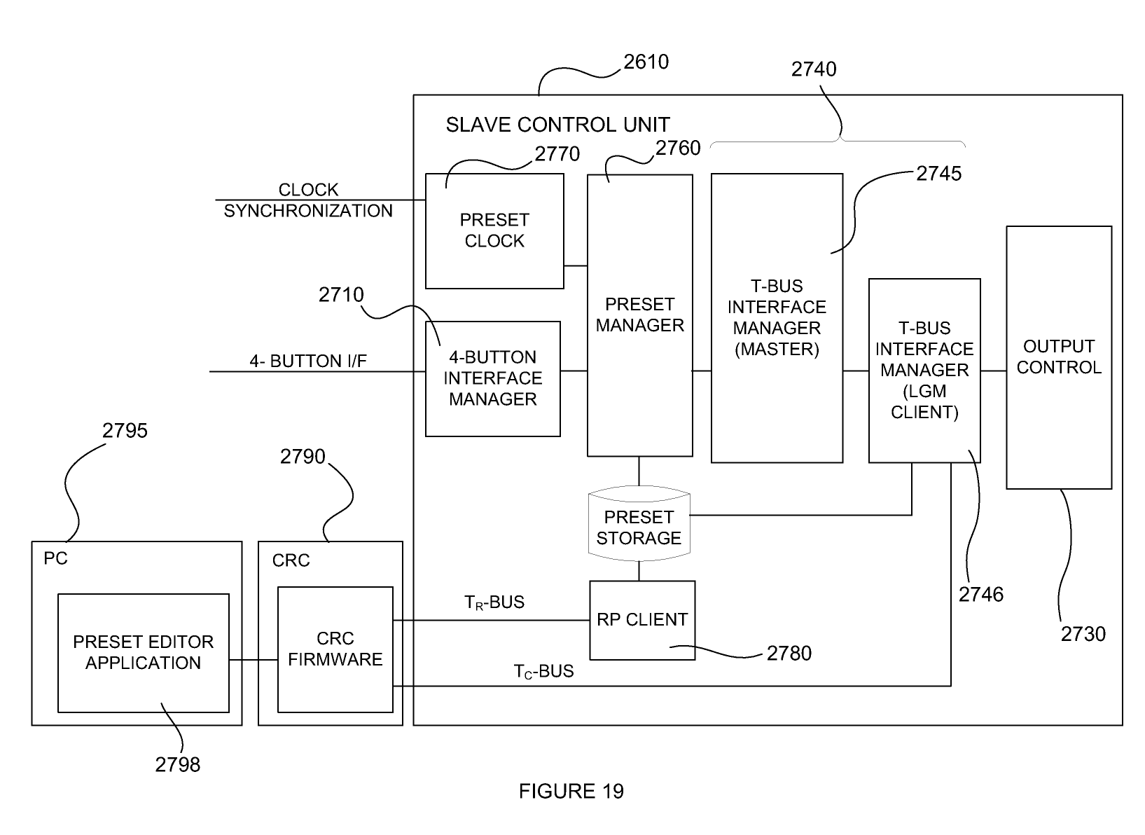

Referring to FIGS. 18 and 19, and in accordance with an example embodiment of the invention, a hardware and firmware architecture of a lighting device, and in particular, of a drive and control system thereof, will now be described. With particular reference to FIG. 18, the drive and control system of a lighting module 2600 generally comprises a slave control unit (SCU) 2610 and an attached light-emitting element module 2620 (e.g. LEE board or the like), the SCU 2610 being operatively configured to receive an external manual input entered via a 4-Button user interface 2630 connected thereto via internal wiring 2650, for example, as similarly described above with reference to FIGS. 13 and 14. In this embodiment, all the firmware for controlling the output of the lighting modules/device resides on the slave control unit 2610.

As described above, the 4-button interface may used in various configurations. In one example, two buttons can enable manual selection of a preset, wherein the two buttons can enable scrolling in a forward or reverse direction through the one or more presets which can be associated with the slave control unit 2610. The other two buttons can be configured to enable adjustment of the luminous flux output of the solid-state lighting system, for example the increase or decrease of the luminous flux output.

In this embodiment, a synchronization interface 2660 is also coupled to the slave control unit 2610, wherein the synchronization interface 2660 can provide timing signals which enable the operation of this particular slave control unit 2510 to be synchronized with other slave control units, thereby enabling a desired illumination design to be created by two or more lighting modules. Internal wiring 2670 for an RS-485 interface is also provided in this embodiment for direct communication with the slave control unit 2610.

FIG. 19 illustrates how the elements of the firmware architecture are allocated to the various processor resources in the hardware architecture of FIG. 18. The presets are implemented on the SCU 2610 and communicated with the output control module 2710 (e.g. component of light generation module) using a T-Bus interconnect system 2740 to issue control commands to the output control module 2710. The various components of this architecture may be described as follows.

4 Button Interface Manager 2710: A firmware interface that interprets user presses of a simple 4 button interface for the control of the output of the LGM.

T-Bus Interface Manager (Master) 2745: A firmware interface that issues commands via the T-Bus communications protocol. The Preset Manager issues commands to the LGM using this interface.

Preset Manager 2760: A firmware control module that implements the preset features.

Preset Clock 2770: The preset clock uses an external time base to correct for errors in the processor clock in order to maintain accurate long duration timing for the Preset Manager.

RP Client 2780: A stand alone client module (e.g. operates separately from the other firmware on the SCU) that implements commands to update the SCU firmware and to update properties in the EEPROM. The RP Client accepts the TR-Bus subset of commands.

T-Bus Interface Manager (LGM Client) 2746: A firmware interface that decodes and executes commands via the T-Bus communications protocol. The LGM implementation accepts a rich selection of commands for controlling a LGM.

Output Control 2730: The main light control firmware of the LGM, and example embodiment of which is described in Example 9 with reference to FIG. 24.

CRC Firmware 2790: The Configuration and Re-flash Connector (CRC) is an interface device that connects between a standard PC COMM port and either a DMX or DALI network. It provides applications residing on the PC with electrical and protocol access to the network and allows those applications to talk to the SCU using T-Bus protocol. Depending on what the application needs to do with the SCU, it can talk using either the TC-Bus protocol to the T-Bus Interface Manager (LGM Client) or using TR-Bus protocol to the RP Client. The application may be configured to control switching between these two modes.

Preset Editor Application 2798: There are several applications that run on a PC that can be used to configure and manage the features on the SCU and the LGM. For the manual control features of the SCU the applicable application is the Preset Editor, which allows creation and editing of Presets.

### Example 7

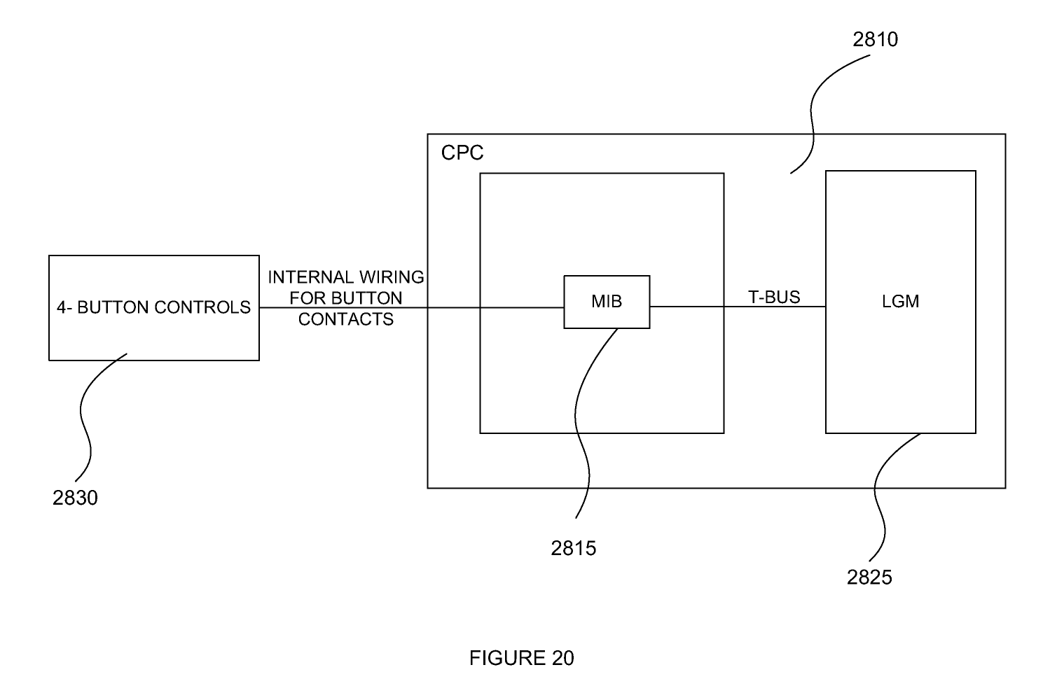

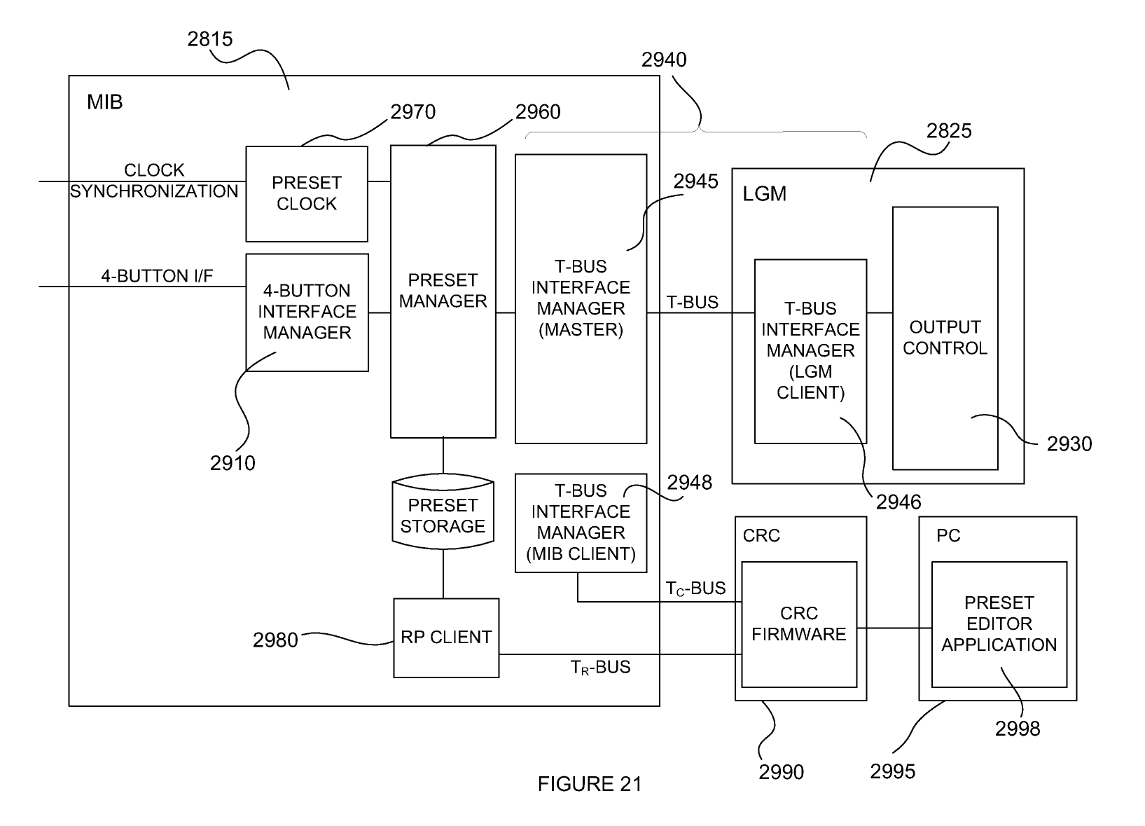

Referring to FIGS. 20 and 21, and in accordance with an example embodiment of the invention, a hardware and firmware architecture of a lighting device/module, and in particular, of a drive and control system thereof, will now be described. In particular, FIG. 20 shows the overall hardware architecture of a manual control interface. As shown, a Multiple Interface Board (MIB) 2815 (e.g. component of a control interface module, as described above) is housed inside a Combined Power and Control (CPC) module 2810, and is communicatively linked to a 4-Button control module 2830 from which an external control input may be provided. Also integrally communicatively linked to the MIB 2815 is a light generation module 2825, for example configured for operative connection to an LEE module (not shown), such as an LEE board or the like, configured to receive from the MIB 2815 control signals and/or commands for operating the LEE module.

For this embodiment, FIG. 21 shows how the elements of the firmware architecture are allocated to the various processor resources in the hardware architecture.

The presets are implemented on the MIB 2818 and communicated with the LGM 2825 using the T-Bus interface to issue control commands to the LGM 2825 and the output control module 2930 thereof.

4 Button Interface Manager (e.g. component of a control interface module) 2910: A firmware interface that interprets user presses of a simple 4 button interface for the control of the output of the LGM.

T-Bus Interface Manager (Master) 2945: A firmware interface that issues commands via the T-Bus communications protocol. The Preset Manager issues commands to the LGM using this interface.

Preset Manager 2960: A firmware control module that implements the preset features.

Preset Clock 2970: The preset clock uses an external time base to correct for errors in the processor clock in order to maintain accurate long duration timing for the Preset Manager.

T-Bus Interface Manager (MIB Client) 2948: A firmware interface that decodes and executes commands via the T-Bus communications protocol. The command set implemented on the MIB is defined as the T_{C}-Bus (Configuration) subset and is relatively limited generally only including a small number of configuration and management commands. The key commands accepted activate the RP Client and allow download of the Presets to the EEPROM.

RP Client 2980: A stand alone client module (e.g. operates separately from the other firmware on the MIB) that implements commands to update the MIB firmware and to update properties in the EEPROM. The RP Client accepts the TR-Bus subset of commands.

T-Bus Interface Manager (LGM Client) 2946: A firmware interface that decodes and executes commands via the T-Bus communications protocol. The LGM implementation accepts a rich selection of commands for controlling a LGM.

Output Control 2930: The main light control firmware of the LGM, and example embodiment of which is described in Example 9 with reference to FIG. 24.

CRC Firmware 2990: The Configuration and Re-flash Converter (CRC) is an interface device that connects between a standard PC COMM port and either a DMX or DALI network. It provides applications residing on the PC with electrical and protocol access to the network and allows those applications to talk to the MIB using T-Bus protocol. Depending on what the application needs to do with the MIB, it can talk using either the Tc-Bus protocol to the T-Bus Interface Manager (MIB Client) or using T_{R}-Bus protocol to the RP Client. The application controls the switching between these two modes.

Preset Editor Application 2998: There are several applications that run on a PC 2995 that can be used to configure and manage the features on the MIB 2815 and the LGM 2825. For the manual control features of the MIB 2815 the applicable application is the Preset Editor, which allows creation and editing of Presets.

### Example 8

With reference to FIG. 23, and in accordance with one embodiment of the invention, an example hardware architecture for supporting a lighting device's control interface module is depicted. The hardware architecture illustratively comprises a Multi-Interface Board (MIB) 1205 providing various control interfaces for external inputs, such as for example, a combination of a button interface 1210 (illustratively a 4-button interface), a DMX (Digital MultipleX) interface 1220, a DALI (Digital Addressable Lighting Interface) interface 1230, and/or other current or future interface 1240, and a T-BUS interface for communicating control signals generated via the MIB 1205 in response to various input controls, to the firmware/hardware platform of the lighting device's light generation module 1202, for example. The T-BUS interface is a communication protocol enabling communication between the MIB and the lighting device. In one embodiment the T-BUS interface can be a proprietary protocol, however other protocol configurations would be readily understood by a worker skilled in the art.

In general, the DMX interface 1220 may provide various methods by which the control system can specify chromaticity output to a light generation module 1202. Formats for these methods may include, but are not limited to: RGB (Red, Green, Blue) intensities; CIE (x,y) or (u′,v′) co-ordinates, and intensity values encoded into DMX data bytes; and CCT (colour temperature) and intensity values encoded into DMX data bytes.

The DALI interface 1230 may also provide various methods by which the control system can specify chromaticity output to a light generation module 1202. These methods may include, but are not limited to the following DALI commands:

Activate xy-Coordinate (Command 1226): Activates previously loaded xy co-ordinates, the intensity then being controlled via a variety of DALI commands;

Set RGB Dimlevel Word (Command 1236): Activates previously loaded RGB intensity values;

Set Colortemp Word (Command 1227): Activates previously loaded correlated colour temperature (CCT) co-ordinates, the intensity then being controlled via a variety of DALI commands; and

Split RGB Addressing: The DALI interface 1230 recognises separate DALI addresses for each of the RGB channels, wherein the controller can then control the intensity of each channel using a variety of DALI commands.

The 4-Button Interface 1210 can be used to provide manual user selection of pre-set scenes (e.g. pre-set chromaticity and intensity). These scenes can specify chromaticity and intensity in formats consistent with those defined for the DMX Interface, for example.

As will be readily apparent to the person skilled in the art, future interfaces 1240 may include new control interfaces developed for the operation and control of the lighting device.

In the present embodiment, regardless of the interface that has been used and the specific format that the controller has chosen to use to send the command, all commands to the lighting device may be translated to the following T-BUS commands.

Set Controlled xy: This command sets the color output, in controlled mode, to the chromaticity specified. The intensity may then be separately controlled using a variety of intensity commands. The time taken by the lighting device to reach the specified chromaticity can be independently specified by a T-BUS command.

Set Controlled u′v′: This command sets the colour output, in controlled mode, to the chromaticity specified. The intensity may then be independently controlled using a variety of intensity commands. The time taken by the lighting device to reach the specified chromaticity can also be independently specified by a T-BUS command.

Set Controlled RGB: This command sets the colour output, in controlled mode, to the RGB values specified. These values may include intensity information that will override the existing intensity. The intensity may then be separately controlled using a variety of intensity commands. The time taken by the lighting device to transition to the specified chromaticity can be independently specified by a T-BUS command.

Set CCT: This command sets the colour output, in controlled mode, to the CCT values specified. The intensity may then be separately controlled using a variety of intensity commands. The time taken by the lighting device to transition to the specified chromaticity can be independently specified by a T-BUS command.

In general, a T-BUS command Set RGBA may also be used to access direct control of the colour channels, and may be available for internal control of the channels by manufacturing and diagnostic utilities. In one embodiment, it is not used by an external interface.

The T-BUS may also comprise numerous additional commands that may be available to set and query properties and status of the light generation module 1202 in support of the output control commands discussed above. As will be apparent to the person skilled in the art, other such commands may also be considered to adapt the present embodiment to different lighting device configurations and lighting combinations.

### Example 9

Referring to FIG. 24, and in accordance with one embodiment of the invention, a lighting control application 1310, e.g. implemented by a control interface and light generation module of a lighting device's drive and control system, will be now be described in greater detail. In particular, FIG. 24 illustrates the various layers and modules of the application's T-BUS Interface 1312, Colour Support Module 1314, Output Control Module 1316 and Application Support Module 1322. As illustrated, global variables 1323 may also be used to simplify the interface between any of the above components.

In general, the T-BUS interface 1312 handles the transmission, reception, decoding and execution of T-BUS messages, and illustratively comprises a T-BUS Data Link Layer 1324 and a T-BUS Command Decoder and Execution Module 1326. In one embodiment, the T-BUS Data Link Layer 1324 may provide features including, but not limited to, the assembly of characters into messages, the transmission of response messages, and the like. The T-BUS Command Decoder and Execution Module 1326 may be used for example, to decode messages received from the T-BUS Data Link Layer 1324, execute command(s) contained in the decoded message(s), generate a response message (e.g. in many applications, most or all T-BUS messages require a response message), and send the response message to T-BUS Data Link Layer 1324 for transmission.

The Colour Support Module 1314 generally provides colour transformation and management functions used to support the execution of T-BUS commands (e.g. generally consistent with interface control module functions described above). In the present embodiment, these functions are illustratively provided by an RGB to XYZ Conversion Module 1330, an xy to XYZ Conversion Module 1332, an u′v′ to XYZ Conversion Module 1334, a Gamut Reduction Module 1336, and a CCT Reduction module 1338. These and other such modules are generally used to receive as input various commands and parameters from the T-BUS Interface 1312 and convert these inputs (e.g. in accordance with a predefined internal control protocol) for use by the Output Control interface module 1316 (e.g. generally consistent with light generation module functions described above). Note that in the illustrated embodiment of FIG. 24, all explicit chromaticity values used internally are represented as XYZ. As such, various functions and modules, as described below, are provided to convert chromaticity values into XYZ coordinates.

In particular, the RGB to XYZ Conversion Module 1332 processes chromaticity values received as RGB values and converts them to XYZ and intensity values for use by the Output Control interface module 1316. In order to support chromaticity transition features, chromaticity settings provided in xy by the T-BUS Interface 1312 are converted to XYZ by the xy to XYZ Conversion Module 1332. Similarly, chromaticity settings provided in u′v′ by the T-BUS Interface 1312 are converted to XYZ by the u′v′ to XYZ Conversion Module 1334.

In some situations, the T-BUS Interface 1312 can request a chromaticity that is outside of the range that is supported by specific models of the lighting device. If this occurs, the Gamut Reduction Module 1336 will use the capabilities of the current instance of the lighting device to reduce the chromaticity to the supported range.

Similarly, the T-BUS Interface 1312 can request a CCT value that is outside of the range that is supported by specific models of the lighting device. If this occurs, the CCT Reduction Module 1338 will use the capabilities of the current instance of the lighting device to reduce the CCT value to the supported range.

As will be discussed further below, chromaticity values, either as XYZ for chromaticity or as mirek (microreciprocal Kelvin) for white light can be further converted to the RGB sensor targets.

Still referring to FIG. 24, the Output Control Module 1316 generally contains modules involved in the actual real time control of the lighting device using as input, the command parameters extracted, and possibly converted, by the Colour Support Module 1314. In the illustrative embodiment of FIG. 24, the Output Control Module 1316 generally comprises a Dynamic Intensity Calculation Module 1340, a Dynamic Colour Chromaticity Calculation Module 1342, and a Dynamic White Chromaticity Calculation Module 1344. Downstream from these modules is further provided an Intensity Scaling Module 1346, a Feedback Loop 1348 (e.g. communicatively linked to a feedback system, such as system 1030 of FIG. 22) and a Drive Module 1350 (e.g. supporting Pulse Width Modulation (PWM) or other such modulation methods) configured to drive the various light-emitting elements of the lighting device. The person of skill in the art will readily understand that other modules and module combinations may be considered to provide similar results without departing from the general scope and nature of the present disclosure.

In one embodiment, a Dynamic Target Calculation Module comprising a Dynamic Intensity Calculation Module 1340, a Dynamic Colour Chromaticity Calculation Module 1342, a Dynamic White Chromaticity Calculation Module 1344 and an Intensity Scaling Module 1346, is responsible for performing all real time chromaticity and intensity transitions. For example, temperature corrected RGB values (RₜGₜBₜ) and active intensity are calculated from target chromaticity and intensity values respectively, and scaled to provide active temperature corrected RₜGₜBₜ for use in driving the lighting device.

In one embodiment, the output of the Dynamic Target Calculation Module is a set of three sensor targets for Red, Green and Blue feedback sensors respectively. Calculating these targets illustratively comprises a three-stage process.

If there is a chromaticity transition in progress, the Module calculates the new chromaticity and updates the current chromaticity to this value, and deducts the cycle time of the dynamic target calculation loop from the remaining time.

If there is an intensity transition in process, the module calculates the new intensity and updates the current intensity with this value, and deducts the cycle time of a dynamic target calculation loop from the remaining time.

The Dynamic Target Calculation Module then scales the RGB targets using the current intensity and a selected dimming curve and outputs this final active set of targets to the feedback loop (e.g. Module 1348).

Note that the firmware code can be optimized to skip either of the transition steps above when neither or only one of the transitions is in progress.

As discussed above, two types of transitions are supported, and each can operate independently of the other. In a chromaticity transition (e.g. Module 1342 or 1344), the new target chromaticity is provided by a T-BUS command and the transition, which varies the current chromaticity from the initial chromaticity to the target chromaticity, begins immediately upon reception of the T-BUS command. In general, the chromaticity transition time is a pre-set value. In one embodiment, the chromaticity transition can be performed as follows:

The T-BUS interface updates the values of the target chromaticity and remaining chromaticity transition time whenever the appropriate commands are received.

The current chromaticity is adjusted at about 50 Hz (i.e., every 20 msec) in equal steps along a straight line between the current RₜGₜBₜ and the target RₜGₜBₜ using step sizes that are appropriate for the current chromaticity transition time and the magnitude of the transition.

The target chromaticity and remaining chromaticity transition time are saved after each loop. In this way if the T-BUS command updates these values before the previous transition is complete, the new values will be automatically used and the new transition will replace the previous one.

If no chromaticity transition is in progress, then the current chromaticity is used as the initial chromaticity.

The intensity transition (e.g. fading or dimming—Module 1340) is generally independent of the chromaticity being displayed. In one embodiment, the new intensity is calculated at about 50 Hz (20 msec) and is synchronized with the chromaticity transition. In one embodiment, the intensity transition is performed as follows:

The T-BUS Interface 1312 updates the values of the target intensity and remaining intensity transition time whenever the appropriate commands are received.

The intensity is adjusted at about 50 Hz (20 msec) in equal steps between the current intensity and the target intensity using a step that is appropriate for the amount of time currently specified for the chromaticity transition time and the magnitude of the intensity change.

The target intensity and remaining intensity transition time are saved after each loop. In this way if the T-BUS command updates these values before the previous transition is complete, the new values will be automatically used and the new transition will replace the previous.

In general, the intensity transition is calculated on a linear percentage scale (although other methods may be considered). Adjustments for the selected dimming curve can also be performed in a following step. If no intensity transition is in progress, then the current intensity is used.

Once the new intensity and chromaticity are calculated, the RₜGₜBₜ values are scaled according to the current intensity (e.g. Module 1346). This calculation implements a scaling based on a currently selected curve setting, which may include, but is not limited to, a square law dimming curve, a linear curve (e.g. linear dimming), a logarithmic curve (e.g. logarithmic dimming compliant with DALI specifications), and the like.

In one embodiment, the Output Control Module 1316 further comprises a Temperature Compensation Module (not shown) responsible for updating temperature related coefficients used in the Feedback Loop 1348. This may also be performed at about 50 Hz (20 msec) and synchronized with one, multiple or all of the above dynamic transition modules (1340, 1342, 1344). In one example, a Temperature Compensation Module may be used to correct for temperature effects on two different sensors and algorithms; one for photodiode temperature compensation, and one for light-emitting element junction temperature compensation. These compensations will be discussed further below.

As introduced above, the Output Control Module 1316 may further comprise a Feedback Loop 1348 configured to implement a main proportional integral (PI) or proportional integral derivative (PID) loop associated with the controller for controlling the output PWM values (PWM drive 1350) based on the RGB target values received from a Dynamic Transition Module (not shown) and the feedback sensor values read from the system hardware (e.g. sensors 1070 and 1080 of the feedback system 1030 of FIG. 22). In one embodiment, the Feedback loop 1348 is not aware of the source of the target values and thus is independent of chromaticity and intensity settings managed in other parts of the firmware.

Due to possible limitations in PWM and feedback sensor hardware, the Feedback Loop 1348 may need to operate in different modes according to the values of the RGB targets provided. If so, such differences may be isolated within the Feedback Loop 1348, which may reduce or avoid having these differences impact other modules in the architecture. In one embodiment, the Feedback Loop 1348 is operated in one of two modes based on whether the PWM values are greater (or equal) to a set threshold value, or lower than this threshold value. In the first case, the algorithm uses the standard intensity and temperature feedback algorithm, whereas in the latter case, all PWM values above the set value operate as normal and continue to use normal intensity and temperature feedback while a PWM value less then the set value operates using historical and calibration light-emitting element data and a temperature feed forward algorithm. Historical temperature data used for this purpose may be collected and saved for each light-emitting element color every time the set threshold is passed, for example. In another embodiment, the selection of operation of the Feedback Loop can be based on the RGB set point or Rₜ, Gₜ, Bₜ.

Alternatively, due to possible loss in resolution at low light levels, the PI or PID parameters of the Feedback Loop 1348 may be varied to ensure speed and stability. This type of algorithm may again be isolated within the Feedback Loop 1348 and consequently, may be used without having an impact on other modules. In this alternative embodiment, when a LED color's target sensor value is greater (or equal) to a set value, the algorithm uses standard PID parameters, however, when a LED color's target sensor value is lower than the set value, the algorithm will decrease the PID parameters, after a preset number of iterations of the feedback loop, to a level proportional to the target sensor value. This will promote a fast response during transient conditions and a stable response (e.g. reduced flicker) at steady state. In another embodiment, the selection of the PID parameters can be based on the PWM values, optical sensor readings or optical sensor set points.

Still referring to FIG. 24, the Output Control Module 1316 further comprises a PWM Drive Module 1350. In general the PWM Drive Module 1350 accepts PWM values for each channel, primarily from the Feedback Loop 1348, and outputs these to the hardware to drive the light-emitting elements of the lighting device. In one embodiment, a secondary interface is provided directly to the T-BUS Module 1312 to allow direct entry of PWM values. In general, this T-BUS interface is not used by an end-user control interface but rather, is provided for the use of manufacturing and support utilities and processes.

As recited above, the lighting control application 1310 further comprises an Application Support Module 1322 that provides several capabilities that provide secondary services to the other modules discussed above. Examples of such secondary services include, but are not limited to, a Start-Up Timer, a Power-Off Module, a Run History Module, a Watchdog, a Configuration Manager, and the like.

The Start-Up Timer generally manages the correct start-up of the lighting device. For example, in one embodiment, the Start-Up Timer disables the lighting device output until sufficient time passes to ensure that all hardware and firmware initialization processes are complete; continues to disable the lighting device output until the currently defined startup delay period has expired (this can be zero, in which case the delay will only be that required for hardware and firmware initialization); upon the expiration of the startup delay, activate the lighting device by setting the current chromaticity and intensity to the currently defined start values; and if T-BUS commands are received that set either chromaticity or intensity values, enable the lighting device by setting the current chromaticity or intensity to these values.

The Power-Off Module is generally enabled by a Real Time Framework when a power-down condition is detected. For example, in one embodiment, the Power-Off Module will disable all output by setting the PWM values to zero and disabling the Feedback Loop 1348 and save the current values of the power-on hours, average temperature and maximum temperature to the non-volatile storage.

The Run History Module generally collects various statistics about the usage of the lighting device. For example, these statistics may include, but are not limited to, total illumination hours, average substrate temperature, average sensor temperature(s), maximum substrate temperature, maximum sensor temperature(s), average PWM for each channel, average sensor level for each channel, average PWM for each channel resolved at 1000 hrs, average sensor level for each channel at 1000 hrs, average substrate temperature for each channel at 1000 hrs, last 10 faults or incidents (e.g. Watchdog, Thermal Derating, PWM Derating, etc.), and the like.

The Watchdog generally processes the interrupt from the Watchdog Timer and attempts to reset and restart the lighting device.

The Configuration Manager generally manages the storing and retrieval of data to the non-volatile storage of the lighting device. While, in one embodiment, the actual driver for the non-volatile store is in a real time framework (not shown), the Configuration Manager may still provide services to map application variables to physical locations.

The lighting control application 1310 further comprises Global Variables used to simplify the interface between some or all of the components listed above. Various example Global Variables and their general usage are listed in Table 1 below.

TABLE 1

| Global | |
|---|---|
| Variable | Usage and Comments |
| Target | Used by Color Control to set the target |
| Chromaticity | chromaticity for the Dynamic Target |
| | Calculation Module to use at its |
| | chromaticity transition target. It is set |
| | whenever a new chromaticity is specified |
| | by the T-BUS or when a timeout causes the |
| | chromaticity to be set to a pre-defined value. |
| Target | Used by Color Control to set the target |
| Intensity | intensity for the Dynamic Target Calcula- |
| | tion Module to use as its intensity transi- |
| | tion target. It is set whenever a new inten- |
| | sity is specified by the T-BUS or when a |
| | timeout causes the intensity to be set to |
| | a pre-defined value. |
| Target RₜGₜBₜ | Output by Color Control to the Control Loop |
| | as the target for the control loop to maintain. |
| Current | Updated by the Dynamic Target Calculation |
| Chromaticity | Module after each cycle to reflect the current |
| | chromaticity supplied to the control loop |
| | (although the actual value supplied to the |
| | control loop is the RₜGₜBₜ calculated from the |
| | Current Chromaticity and Current Intensity). |
| | A T-BUS command is available to read this value. |
| Current | Updated by the Dynamic Target Calculation |
| Intensity | Module after each cycle to reflect the |
| | current intensity supplied to the control |
| | loop (although the actual value supplied to |
| | the control loop is the RₜGₜBₜ calculated |
| | from the Current Chromaticity and Current |
| | Intensity). A T-BUS command is available to |
| | read this value. |
| Remaining | Set by Color Control to the Chromaticity Fade |
| Chromaticity | Time whenever the Target Chromaticity is set. |
| Fade Time | A value of zero is legal indicating an instan- |
| | taneous change. |
| | Updated by the Dynamic Target Calculation module |
| | after each cycle to reflect the remaining time |
| | of a chromaticity transition. A T-BUS command |
| | is available to read this value. |
| Remain | Set by Color Control, to the Intensity Fade |
| Intensity Fade | Time whenever the Target Chromaticity is set. |
| Time | A value of zero is legal indicating an instan- |
| | taneous change. |
| | Updated by the Dynamic Target Calculation Module |
| | after each cycle to reflect the remaining time |
| | of an intensity transition. A T-BUS command is |
| | available to read this value. |

The above discussion, cast mainly with reference to the embodiment of FIG. 24, provides an example implementation of the lighting control application 1310. Not shown in FIG. 24 is the tasking structure that controls the timing of the execution of the real time critical components, which may be cooperatively implemented by a Real Time Framework and Real Time Support Module (not shown), for example. In general, the Real Time Framework provides facilities for prioritized and nested interrupts for the hardware drivers and a tasking mechanism for the application 1310 based on a system timer. Facilities to queue data between these tasks and to provide mutual exclusion for the access of shared data are provided. In one embodiment, the following major interrupt and timer tasks are visible to the application 1310.

Serial Interrupts: The T-BUS Data Link Layer 1324 is implemented in the transmit and receive interrupts, as appropriate. A queue for fully assembled and error checked messages is provided to the T-BUS Command Decoder and Execution module 1326.

Feedback Loop: The Feedback Loop 1348 is implemented in a timer task. In one embodiment, this task is executed at approximately 300 Hz, though other frequencies may be considered, as will be apparent to the person skilled in the art.

Dynamic Target Calculation Task (DTCT): The DTCT is a timer task which is configured to execute Dynamic Target Calculation and Temperature Compensation Modules. In one embodiment, this task is executed at approximately 50 Hz, though other frequencies may be considered, as will be apparent to the person skilled in the art.

Background Task: The T-BUS Command Decoder and Execution Module 1326 and the Color Support set of modules executes in the Background Task. The Background Task loops as quickly as possible using processor time not being used by the other tasks.

Applications Support Tasks: The Applications Support Module 1322 supports several tasks and timer threads that provide support functions.

### Data Formats and Storage

In general, the Configuration Manager (see FIG. 24) provides services for the storage and retrieval of persistent values in non-volatile storage. T-BUS commands are provided to set and retrieve these values.

Each time the firmware boots, the firmware will examine the non-volatile storage to ensure that the storage is intact and uncorrupted. It will also determine if the non-volatile storage format is correct for the firmware load. If either of these tests determines that the non-volatile storage is invalid, the firmware shall update the non-volatile storage with hard-coded factory defaults. Typically this should only happen on a new device when the non-volatile storage is empty. A T-BUS command for this purpose shall also be supplied.

### Example 7

An example of encoding requirements can be defined as follows, in accordance with one embodiment of the invention:

### Start Code 0x00 Processing

1. Start code 0x00 processing shall depend upon the current DMX mode that has been specified for the lighting device:
a. RGB (Red Green Blue) Mode
b. RGBA (Red Green Blue Amber) Mode
c. CCT (Correlated Colour Temperature) Mode
d. Dynamic RGB Mode
e. Dynamic CCT Mode
f. Dynamic xy Mode
g. Dynamic u′v′ Mode
h. Dynamic Preset Mode

2. In the detailed descriptions of each of these modes, the byte offset listed shall be the offset from the programmed DMX address for the device.

3. For those modes that include a Intensity Fade Time and/or a Chromaticity Fade Time, the value shall be interpreted as follows:
a. The value shall provide the appropriate fade time in seconds. This allows fade times from 0 to 255 seconds with a resolution of one second.
b. If the value of the fade time in a subsequent packet changes while a fade is still in progress, the fade timer shall be restarted using the new value.

4. The CIE xy chromaticity coordinates of Red, Green and Blue in all cases where they are used in the commands shall be as follows (though other chromaticity coordinates may be considered, as will be apparent to those skilled in the art):
Red (x, y) Green (x, y) Blue (x, y): {0.640, 0.330}, {0.290, 0.600}, {0.150, 0.060}

5. The output chromaticity of the light generated by the light generation module when the RGB inputs each specify the same intensity shall be a configuration parameter of the light generation module which can be set using the configuration application.

6. In all cases where the chromaticity is specified as a set of RGB values, this chromaticity shall be used as input to the light generation module's interdependently controlled output capabilities. As a result, the light generation module will actively manage the output of each channel, as well as the optional Amber channel in order to maintain the specified chromaticity. Therefore the drive current output of each channel will only approximate the input values supplied.

7. There shall be no capability in this DMX interface to allow direct drive of the output channels.

### RGB Mode

The RGB Mode data bytes are as follows:
a. Byte Meaning
b. 0 Red Intensity from 0% to 100% in 255 steps;
c. 1 Green Intensity from 0% to 100% in 255 steps;
d. 2 Blue Intensity from 0% to 100% in 255 steps.

### RGBA Mode

The RGBA Mode data bytes are as follows:
a. Byte Meaning
b. 0 Red Intensity from 0% to 100% in 255 steps
c. 1 Green Intensity from 0% to 100% in 255 steps
d. 2 Blue Intensity from 0% to 100% in 255 steps
e. 3 Amber—Value ignored, accepted for backward compatibility only
   xy Mode

The xy Mode data bytes are as follows:
a. Byte Meaning
b. 0 x value from 0% to 100% in 255 steps
c. 1 y value from 0% to 100% in 255 steps
d. 2 Intensity from 0% to 100% in 255 steps

### CCTMode

1. The CCT Mode data bytes are as follows:
a. Byte Meaning
b. 0 CCT in K encoded as specified below, in 255 steps;
c. 1 Intensity from 0% to 100% in 255 steps.

2. The encoding of the CCT shall be according to the formula [Intensity=1,000,000/CCT−154] which will allow the CCT to range from 6500K to 2439K.

Note that this may be beyond the range of support CCT for the light generation module, in which case the maximum or minimum CCT supported by the light generation module as appropriate shall be displayed.

### Dynamic RGB Mode

1. The Dynamic RGB Mode data bytes are as follows:
a. Byte Meaning
b. 0=0x00—Dynamic RGB Mode
c. 1 Red Intensity from 0% to 100% in 255 steps
d. 2 Green Intensity from 0% to 100% in 255 steps
e. 3 Blue Intensity from 0% to 100% in 255 steps
f. 4 Unused
g. 5 Master Intensity from 0% to 100% in 255 steps
h. 6 Intensity Fade Time
i. 7 Chromaticity Fade Time

2. The intensity of the output of each channel shall be calculated by multiplying the individual intensity of each channel by the Master Intensity.

3. If the RGB values select a chromaticity that is beyond the display capability of the light generation module then the chromaticity shall have its purity reduced until the resulting chromaticity can be displayed.

### Dynamic CCTMode

1. The Dynamic CCT Mode data bytes are as follows:
a. Byte Meaning
b. 0=0x01—Dynamic CCT Mode
c. 1 CCT—High Byte
d. 2 CCT—Low Byte
e. 3 Unused
f. 4 Unused
g. 5 Intensity from 0% to 100% in 255 steps
h. 6 Intensity Fade Time
i. 7 CCT Fade Time

2. The CCT value shall be stored in mirek, in the range 1-65279. Note that this allows a color temperature range of 15.32K to 1,000,000K.

3. If the CCT selected is beyond the range of supported CCT for the light generation module, the maximum or minimum CCT supported by the light generation module as appropriate shall be displayed.

### Dynamic xy Mode

1. The Dynamic xy Mode data bytes are as follows:
a. Byte Meaning
b. 0=0x02—Dynamic xy Mode
c. 1x—High Byte
d. 2x—Low Byte
e. 3 y—High Byte
f. 4 y—Low Byte
g. 5 Intensity from 0% to 100% in 255 steps
h. 6 Intensity Fade Time
i. 7 Chromaticity Fade Time

2. Each coordinate of the xy color point shall be stored in fixed format with the following limits: 0x000=0.000; 0xFE9=1.000

3. If the xy coordinate selects a chromaticity that is beyond the display capability of the light generation module then the chromaticity shall have its purity reduced until the resulting chromaticity can be displayed.

### Dynamic u′v′ Mode

1. The Dynamic u′v′ Mode data bytes are as follows:
a. Byte Meaning
b. 0=0x03—Dynamic xy Mode
c. 1 u′—High Byte
d. 2 u′—Low Byte
e. 3 v′—High Byte
f. 4 v′—Low Byte
g. 5 Intensity from 0% to 100% in 255 steps
h. 6 Intensity Fade Time
i. 7 Chromaticity Fade Time

2. Each coordinate of the u′v′ color point shall be stored in fixed format with the following limits: 0x000=0.000; 0xFE9=1.000.

3. If the u′v′ coordinate selects a chromaticity that is beyond the display capability of the light generation module then the chromaticity shall have its purity reduced until the resulting.

### Dynamic Preset Mode

1. The Dynamic Preset Mode data bytes are as follows:
a. Byte Meaning
b. 0 0x04=Dynamic Preset Mode
c. 1 Preset Id (1-32)
d. 2 Sync Counter High Byte
e. 3 Sync Counter Low Byte
f. 4 Unused
g. 5 Master Intensity from 0% to 100% in 255 steps
h. 6 Unused
i. 7 Unused

2. The sync counter is used to establish a repetitive signal for the use of the luminaries to synchronize the display of dynamic presets according to the following requirements:
a. The Sync Counter shall be incremented by the controller every 30 seconds;
b. When the Sync Counter reaches 50,000, it shall be reset to 0.

### Performance Requirements

1. The DMX interface shall be capable of receiving DMX packets at the maximum arrival rate specified, that is:
a. Data Rate=250K bps;
b. Minimum Packet Transmission Rate=1,096 μs per packet.

2. The DMX interface shall be capable of processing DMX packets at the rate of 44.115 Hz. This is the maximum arrival rate for full size DMX packets.

3. Packets that arrive at greater than the maximum processing rate may be dropped by the DMX interface.

4. If packets are arriving at faster than the maximum processing rate, then interface shall processes at least the number of packets required by the maximum processing rate and may discard the excess.

### Configuration Application Requirements

A configuration program that uses Proprietary Protocol-Bus protocol to communicate with the device is required.

For the purposes of supporting the DMX firmware, the application shall be capable of setting the following DMX parameters.

1. DMX Address: Enter DMX address in the range of 1-512.

2. DMX Operating Mode: Select one of the following operating modes:
a. RGB
b. RGBA
c. CCT
d. Dynamic. When dynamic mode is selected, the data itself is used to select which dynamic mode is used.

3. Presets: Edit and download presets into the light generation module.

4. RGB 100% Chromaticity: When the chromaticity is selected using either of the RGB modes, the exact chromaticity of the output when all RGB channels have an equal input value shall be selectable from the following options (though other correlated color temperatures or chromaticities may be considered, as will be apparent to those skilled in the art):
a. 3000K
b. 4000K
c. 6500K
d. The chromaticity that produces the highest lumen output of the light generation module.

The foregoing embodiments of the invention are examples and can be varied in many ways. Such present or future variations are not to be regarded as a departure from the spirit and scope of the invention, and all such modifications as would be apparent to one skilled in the art are intended to be included within the scope of the following claims.

We claim:

1. A system for controlling generation of light from one or more light-emitting elements in response to an external input, the system comprising:
a control interface module configured to receive the external input and convert same in accordance with a predefined internal control protocol; and
a light generation module communicatively linked to said control interface module and operatively linked to the one or more light-emitting elements for controlling same in accordance with said converted input.

2. The system as claimed in claim 1, wherein said control interface module is interchangeable or interchangeably adaptable to receive the external input when configured in accordance with any one of two or more external control protocols, and convert same in accordance with a same said predefined control protocol.

3. The system as claimed in claim 1, wherein the external input defines a preset in accordance with which the generation of light is to be controlled.

4. The system as claimed in claim 3, wherein said control interface module is configured to automatically detect a change in said external control protocol and implement a corresponding protocol conversion in response thereto.

5. The system as claimed in claim 1, the system comprising a control system for providing general illumination via the one or more light-emitting elements.

6. The system as claimed in claim 1, wherein said control interface module is configured to receive the external input via one or more of a DALI interface, a DMX interface, a manual interface and a proprietary protocol interface, and convert same in accordance with said predefined internal control protocol.

7. The system as claimed in claim 1, the system further comprising a feedback system configured to communicate one or more feedback signals representative of an operating condition of the system to said light generation module, said light generation module being further configured for adjusting generation of light from the one or more light-emitting elements in response to said one or more feedback signals.

8. The system as claimed in claim 7, wherein said one or more feedback signals comprise one or more optical feedback signals representative of an optical output of the one or more light-emitting elements.

9. The system as claimed in claim 7, wherein said one or more feedback signals comprise one or more thermal feedback signals representative of an operating temperature of the one or more light-emitting elements.

10. The system as claimed in claim 8, wherein said one or more feedback signals further comprises one or more thermal feedback signals representative of an operating temperature of an optical sensing element configured to provide said one or more optical feedback signals, said one or more thermal feedback signals thereby allowing for an adjustment of a response of said light generation module to said one or more optical feedback signals.

11. The system as claimed in claim 1, the system for controlling generation of light from one or more light-emitting elements of a plurality of lighting modules in a lighting system, each lighting module comprising a respective light generation module, the system further comprising a master control module configured to provide the external input to each said respective light generation module via one or more of a respective control interface module and a common control interface module.

12. The system as claimed in claim 1, the system further comprising an input/output module via which the external input is provided to said control interface module.

13. A method for controlling generation of light from one or more light-emitting elements in response to an external input, the method comprising the steps of:
receiving the external input;
converting the external input in accordance with a predefined internal control protocol; and
controlling generation of light from the one or more light-emitting elements in accordance with said converted input.

14. The method as claimed in claim 13, said receiving step comprising receiving the external input via any one of two or more external input interfaces, the method further comprising the step before said converting step of identifying from which of said two or more external input interfaces the external input is received, and converting same accordingly.

15. The method as claimed in claim 14, wherein said identifying step is implemented automatically via a computing module operatively coupled to said two or more external input interfaces.

16. The method as claimed in claim 15, wherein said identifying step comprises identifying an instance where the external input is not being received via a current one of said two or more external input interfaces, and automatically switching to another one of said two or more external input interfaces in response to said instance.

17. The method as claimed in claim 16, wherein said instance is defined by a predetermined time delay.

18. A lighting system comprising:
an external input module; and
one or more lighting modules each comprising one or more light-emitting element modules and a slave control unit operatively coupled thereto for driving said one or more light-emitting element modules;
each said slave control unit being communicatively linked to said external input module to receive an external input therefrom via a control interface;
said control interface configured to convert said external input in accordance with a predefined internal control protocol operable by said slave control unit to drive said one or more light-emitting element modules in accordance therewith.

19. The lighting system as claimed in claim 18, wherein the external input defines a common or respective preset in accordance with which said one or more light-emitting element modules of each of said one or more lighting modules are to be driven.

20. The lighting system as claimed in claim 18, wherein said external input module comprises a master control module.

21. The lighting system as claimed in claim 18, wherein said external input module comprises one or more of a remote I/O module and an integrated I/O module.

22. The lighting system as claimed in claim 18, wherein said external input module is selected from the group consisting of, a DMX controller, a DALI controller, a manual input interface and a proprietary controller.

23. The lighting system as claimed in claim 18, wherein each said slave control unit comprises a control interface module configured to provide said control interface, and a light generation module operatively coupled thereto for driving said one or more light-emitting element modules operatively coupled thereto in accordance with said converted external input.

24. The lighting system as claimed in claim 18, wherein said control interface is interchangeable or interchangeably adaptable to receive the external input when configured in accordance with any one of two or more external control protocols, and convert same in accordance with a same said predefined control protocol.

25. The lighting system as claimed in claim 18, wherein said slave control unit is configured to receive said external input when configured in accordance with in any one of two or more external control protocols, automatically detect which of said two or more external control protocols is being used, and convert said external input accordingly.
